(19) United States
(12) Patent Application Publication
(10) Pub. No.: US 2013/0268377 A1
(43) Pub. Date: Oct. 10, 2013

(54) GIFT COLLABORATION SOCIAL NETWORK SERVICE

(71) Applicants: Brian Arthur JESSUP, San Diego, CA (US); James Henry Allan PUDERER, Ottawa (CA)

(72) Inventors: Brian Arthur JESSUP, San Diego, CA (US); James Henry Allan PUDERER, Ottawa (CA)

(21) Appl. No.: 13/607,143

(22) Filed: Sep. 7, 2012

Related U.S. Application Data
(60) Provisional application No. 61/532,006, filed on Sep. 7, 2011.

(51) Int. Cl. G06Q 50/00

(52) U.S. Cl. CPC G06Q 50/01; G06Q 30/0605
USPC 705/14.73; 705/319; 705/27.1; 705/26.2

(57) ABSTRACT

Techniques for facilitating collaboration on gift ideas for a receiver are provided. An example method according to the disclosure includes creating a group for discussing gift ideas for the receiver in response to a request from a user, receiving a gift idea from a member of the group, and providing a group collaboration interface in which members of the group can post messages discussing the gift idea.

### CROSS-REFERENCE TO RELATED APPLICATION

This application claims priority to U.S. provisional patent application no. 61/532,006, titled “GIFT RECOMMENDATION SOCIAL NETWORK SERVICE,” filed on Sep. 7, 2011, which is incorporated herein by reference in its entireties for all purposes.

### BACKGROUND

Social networking services provide a convenient way for people to electronically communicate with friends and family, and share content such as photos and/or video content. Social networking services have also expanded into the business world to provide professional networking services that allow people and businesses to build a network of connections that allows them to share information with current clients, potential clients, and colleagues.

### BRIEF DESCRIPTION OF THE DRAWINGS

The appended drawings are provided to illustrate and not to limit the disclosed examples, wherein like designations denote like elements, and in which:

FIG. 1 is a high level block diagram of a gift collaboration system.

FIG. 2 is a block diagram of a gift network server that can be used to implement a gift service server illustrated in FIG. 1.

FIG. 3 is an example of a group view interface that can be provided by the gift collaboration system illustrated in FIG. 1.

FIG. 4 is a diagram of an invite to group interface that can be provided by the gift collaboration system illustrated in FIG. 1.

FIG. 5 is an example of a group settings interface 500 that can be provided by the gift collaboration system.

FIG. 6 illustrates an example of the interface of FIG. 5 where one of the administrators has been selected.

FIG. 7 illustrates an example of a group interface 700 that allows members of the group to interact with the gift collaboration system.

FIG. 8 illustrates an example of a gift idea interface that can be provided by the gift collaboration system illustrated in FIG. 1.

FIG. 9 illustrates an example of a gift idea interface that can be provided by the gift collaboration system illustrated in FIG. 1.

FIG. 10 illustrates additional aspects of the gift idea interface of FIG. 9.

FIG. 11 illustrates additional aspects of the gift idea interface of FIG. 9.

FIG. 12 illustrates additional aspects of the gift idea interface of FIG. 9.

FIG. 13 illustrates additional aspects of the gift idea interface of FIG. 9.

FIG. 14 illustrates additional aspects of the gift idea interface of FIG. 9.

FIG. 15 illustrates additional aspects of the gift idea interface of FIG. 9.

FIG. 16 illustrates additional aspects of the gift idea interface of FIG. 9.

FIG. 17 illustrates additional aspects of the gift idea interface of FIG. 9.

FIG. 18 illustrates additional aspects of the gift idea interface of FIG. 9.

FIG. 19 illustrates additional aspects of the gift idea interface of FIG. 9.

FIGS. 20 illustrates an add a gift idea interface that can be used to associate a gift idea with a group.

FIG. 21 illustrates additional aspects of the gift idea interface illustrated in FIG. 20 that can be used to associate a gift idea with a group.

FIG. 22 illustrates additional aspects of the gift idea interface illustrated in FIGS. 20 and 21 that can be used to associate a gift idea with a group.

FIG. 23 illustrates a gift idea settings interface that can be used to associate a gift idea with a group.

FIG. 24 illustrates a wish list item interface that is similar to the gift idea interface of FIG. 9.

FIG. 25 is an example of a wish list settings interface that can be provided by the gift collaboration system to allow a receiver to configure the privacy settings the user's wish list.

FIG. 26 illustrates an example of the gift idea interface of FIG. 9 where a gift item has been claimed.

FIG. 27 illustrates an example of the gift idea interface of that includes fields for capturing information about the collaborative purchase.

FIG. 28 is an example of the gift idea interface that includes additional collaborative purchase parameters.

FIG. 29 is an example of the gift idea interface that includes fields for capturing payment account information.

FIG. 30 is an example of the gift idea interface that includes a confirmation that the user has linked a payment account to a collaborative purchase.

FIG. 31 illustrates an example of the gift idea interface has been updated to display the collaborative purchase details.

FIG. 32 illustrates another example of the gift idea interface has been updated to display the collaborative purchase details.

FIG. 33 illustrates an example of the gift idea interface where a user has clicked the contribute button illustrated in FIG. 32 and the collaborative purchase details have been updated to allow the user to enter payment account information.

FIG. 34 illustrates a view of the gift idea interface after the user has entered the payment account information and the collaborative purchase details are displayed.

FIG. 35 illustrates a view of the gift idea interface where the collaborative purchase details include a confirmation of the contribution made by the user.

FIG. 36 is a flow diagram of a method for facilitating collaboration on gift ideas for a recipient in the gift collaboration system.

FIG. 37 is a flow diagram of a method for adding members to a group in the gift collaboration system.

FIG. 38 is a flow diagram of a method for creating a new gift idea in the gift collaboration system.

FIG. 39 is a flow diagram of a method for processing a request to claim a gift in the gift collaboration system.

FIG. 40 is a flow diagram of a method for processing a request to purchase a gift in the gift collaboration system.

FIG. 41 is a flow diagram of a method for processing a request for collaborative purchasing of a gift in the gift collaboration system.

### SUMMARY

An example method for facilitating collaboration on gift ideas for a receiver according to the disclosure includes creating a group for discussing gift ideas for the receiver in response to a request from a user, receiving a gift idea from a member of the group, and providing a group collaboration interface in which members of the group can post messages discussing the gift idea.

An example system for facilitating collaboration on gift ideas for a receiver according to the disclosure includes means for creating a group for discussing gift ideas for the receiver in response to a request from a user, means for receiving a gift idea from a member of the group, and means for providing a group collaboration interface in which members of the group can post messages discussing the gift idea.

An example computer-readable storage medium, having stored thereon computer-readable instructions for facilitating collaboration on gift ideas for a receiver, according to the disclosure includes instructions configured to cause at least one processor to: create a group for discussing gift ideas for the receiver in response to a request from a user, receive a gift idea from a member of the group, provide a group collaboration interface in which members of the group can post messages discussing the gift idea.

An example system for facilitating collaboration on gift ideas for a receiver according to the disclosure includes a non-transitory computer-readable memory, a plurality of modules comprising processor executable code stored in the non-transitory computer-readable memory, a processor connected to the non-transitory computer-readable memory and configured to access the plurality of modules stored in the non-transitory computer-readable memory. The system also includes a group module configured to create a group for discussing gift ideas for the receiver in response to a request from a user, and a user interface module configured to receive a gift idea from a member of the group and to provide a group collaboration interface in which members of the group can post messages discussing the gift idea.

### DETAILED DESCRIPTION

Techniques for collaborative gift giving are provided. A gift collaboration system is provided that has aspects of a social network but is built around collaboration between users to suggest, discuss, and purchase gifts for specific receiver. The gift collaboration system allows users to solicit recommendations from other users for ideas regarding gifts for the receiver of the gift. The system allows users to create and participate in group discussion threads that can be associated with a particular gift and/or recipient of a gift. The discussions threads associated with a particular gift and/or recipient are private and only visible to members of the group of users that has been invited to participate in the discussion. The discussions can be kept private from the intended recipient of the gift. Users of the gift recommendation service can use the service at a time while those users are actively seeking to make a purchasing decision and will be seeking support from other users to make that decision.

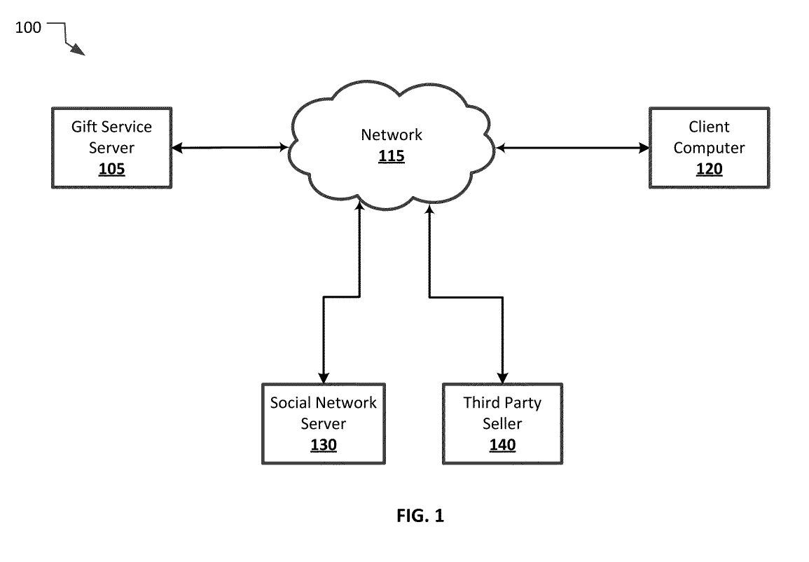

FIG. 1 is a high level block diagram of a gift collaboration system 100. The system 100 includes a gift service server 105. The gift service server 105 is connected to network 115. The network 115 can comprise one or more wireless and/or wired networks. The network 115 can be the Internet. The gift service server 105 can communicate with a plurality of client device 120, one or more social network servers 130, and one or more third party sellers 140.

The gift service server 105 can be configured to allow users to create groups and invite other users of the gift network service to collaborate on gift ideas for a receiver associated with the groups, users of the social network services provided by the at least one social network 130, and/or other non-users of either service who can be invited to participate and create a new user account.

Each group can be associated with a particular recipient or event for which one or more gifts are to be purchased. One or more users can then be invited to participate in the group. These users can provide input to help solve the problem of what to buy for the intended receiver or receivers of the gift. For example, a user creating a group may want to purchase a thoughtful, sentimental, surprise gift for his wife's birthday, but the user is unsure what to get her. The husband could then create a new group associated for selecting a gift for his wife's birthday, and invite friends and family members to participate in the group. The members of the group can then post gift ideas and/or specific gift items related to gift ideas and can collaborate with other members to discuss the various gift ideas, claim gifts that the members would like to purchase for the receiver, and/or make purchase of gift items.

The gift service server 105 can be configured to allow the users to post information associated with gift ideas and/or specific gift items, including photos of items, links to online retails selling the items, and/or other information related to gifts, including gifts that are available from retailers that do not have an online presence. The gift service server 105 can be configured to analyze content that is posted to discussion threads and to display links to online retailers where suggested items can be purchased. The gift service server 105 can also be configured to suggest other items that may satisfy a user's requirements based on the attributes of items that are suggested by members of the group or attributes of the targeted receiver. For example, if users of the group suggest jewelry, the gift service server 105 can be configured to display links to jewelry items that can be purchased online. As members of the group provide more detail about what they believe the recipients or set of recipients would like to receive as gift, the gift service server 105 can refine and improve the suggestions. For example, returning to the jewelry example, if users in the group indicate that the recipient likes the color blue, the gift service server 105 can select jewelry that includes sapphires or other blue gemstones. The suggestions can also be based at least in part on past purchases. For example, the size information for clothing or jewelry items could be suggested based on past purchases made by the receiver and/or by others making purchases for the receiver. The suggestions can also be based at least in part on the “ranking” associated with the suggestor of a gift. For example, in some implementations, a suggestor can be ranked, at least in part, based on the number of favorable votes that other members have entered for gift ideas suggested by the suggestor. In some implementations, the receiver can also indicate whether he or she liked a particular gift and this information can be used to select and rank suggestions. Furthermore, suggestions can also be ranked based on items that are currently on the recipient's wish list and/or were included on the recipient's wish list in the past.

The gift service server 105 can provide a user interface that allows member of a group to purchase recommended gifts. The gift service server 105 can also be configured to provide an interface that allows users to participate in collaborative buying of gifts. For example, multiple members of a group could each contribute toward the purchase price of a gift for the recipients or recipients. Numerous examples of interfaces that can be provided by the gift service server 105 are discussed in greater detail below.

The gift service server 105 can also be configured to provide for assisted discussions, and the gift service server 105 can suggest cross-linking or combination of groups and/or gift ideas. For example, the gift service server 105 can be configured to recognize that multiple groups have been created regarding the same recipient or set of recipients. The gift service server 105 can be configured to display a message to the creators of the groups that the two groups may be related and could be cross-linked or combined to provide members that have access to the first group with access to the second group and vice versa.

The client devices 120 can comprise a network-connected device capable of requesting and displaying web content, such mobile phones, tablet or handheld computer systems, personal digital assistants, laptop or desktop computer systems. Each client device 120 is associated with a display component that can display a web-based interface and/or be configured to execute an application that provides an interface to the gift collaboration system 100 that is provided by gift service server 105. Each client device 120 includes one or more processors capable executing software comprising processor-executable instructions and can include a combination of persistent and non-persistent computer readable memory. The client device 120 can be configured to communicate via the network 115 using either a wired and/or a wireless connection. Client device 120 can also communicate with the at least one social network servers 130 to allow the user to access content provided by the social network services operating on the at least one network servers 130.

The at least one social network server 130 provides a conventional social network service where users can communicate with other users and share content such as photos. The gift service server 105 can be implemented on a social network server 130. In some implementations, the gifts collaboration service provided by the gift collaboration system 130 can be implemented as an application that can be integrated with and accessed through a social networking service.

The gift service server 105 can be configured to provide content to users of the social network services provided by the at least one social network server 130. For example, the gift recommendation related content and services provided by the gift service server 105 can be integrated with content provided by the social network to provide users of the social network with seamless access to the gift recommendation services provided by the gift service server 105 to users of the social network services. In other implementations, the gift service server 105 can be configured to provide gift recommendation services that are not integrated with social network content. In yet other implementations, the gift service server 105 can be configured to integrate with some services of one or more social network services. For example, authentication services of the gift recommendation services and a social network service can be integrated to allow users to log into the gift recommendation service using their credentials from the social network service or vice versa. In some implementations, at least a portion of a user's profile information from the social network services can be imported into the gift recommendation service when a user of a social network service registers with the gift recommendation service and/or accesses the gift recommendation service using their user credentials from the third party social network service.

The gift service server 105 can also interface with third party seller server 140 to allow members of a group to purchase or participate in the collaborative purchase of items offered for sale by the third party seller. The gift service server 105 can be configured to provide an electronic shopping cart interface that can collect payments from members and transfer the payments to the online retailer to purchase the desired goods or services from the third party retailer. The gift service server 105 can also be configured to redirect members to the third party retailer's site to complete the sales of the goods or services.

The gift service server 105 can also be configured to allow members of a group to “claim” certain gifts for purchase for a user. For example, if a group is created for a college student who is about to graduate from college and the student's aunt is a member of the group, the aunt could claim a particular gift to purchase for the student. The gift service server 105 can be configured to redirect the aunt to a purchase interface to allow her to complete the purchase online. The gift service server 105 can also be configured to allow the aunt to place a hold on the gift and to purchase the gift offline or online but outside of the gift recommendation service provided by the gift service server 105. The gift service server 105 can be configured to place the gift on hold for a limited period of time. In some implementations, a user reserving a gift can be sent an email message by the gift service server 105 that includes a link that that the user can click to confirm that the user has purchased the gift. In some implementations, the member purchasing the gift can also return to the gift recommendation service prior to the expiration of the limited time period to confirm that the purchase was made. Otherwise, if the user does not confirm that the gift was purchased before the expiration of the limited hold period, the gift could be release for purchase by other members of the group.

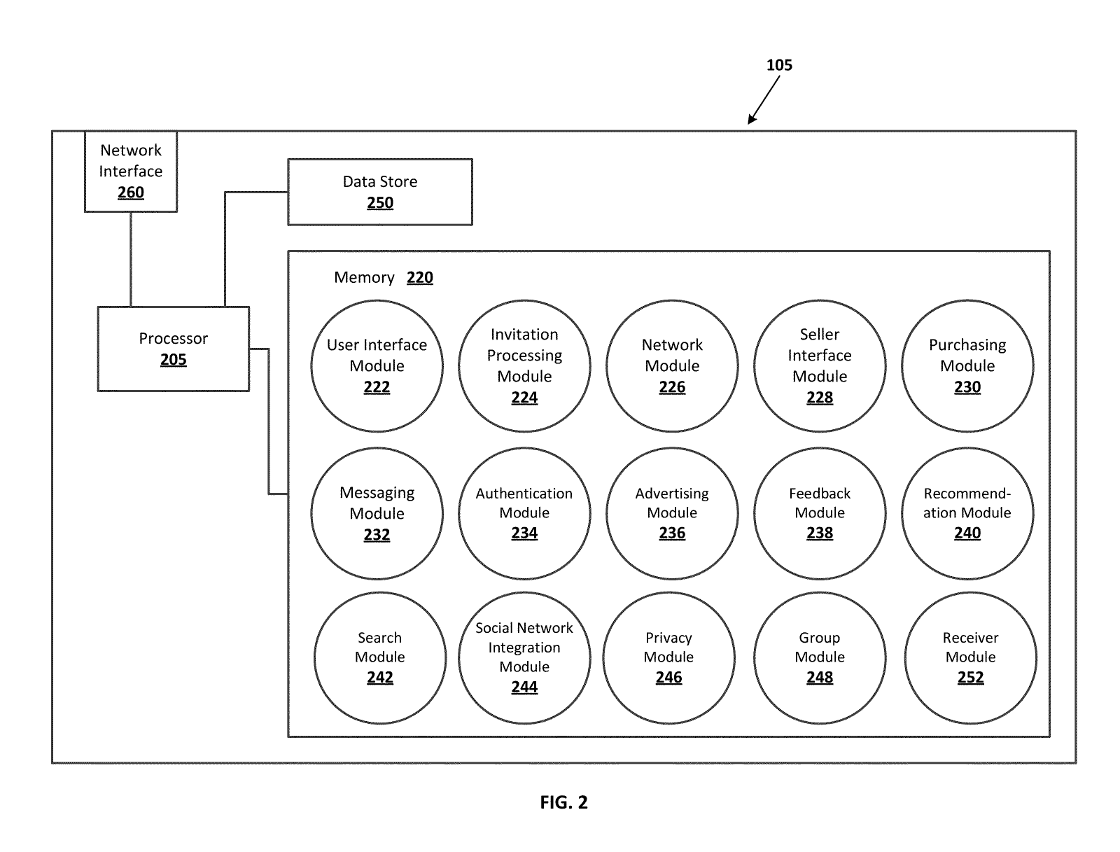

FIG. 2 is a block diagram of a gift network server that can be used to implement the gift service server 105 illustrated in FIG. 1. The gift service server 105 includes a processor 205, a memory 220, a data store 250, and a network interface 260.

The processor 205 can comprise one or more microprocessors configured to access memory 220. The processor 205 can read data from and write data to memory 220. The processor 205 can also read executable program code from memory 220 and execute the program code.

The memory 220 includes a user interface module 222, an invitation processing module 224, a network module 226, a seller interface module 228, a purchasing module 230, a messaging module 232, an authentication module 234, an advertising module 236, a feedback module 238, a recommendation module 240, a search module 242, a social network integration module 244, and a privacy module 246, a group module 248, and a receiver module 252. The memory 220 can comprise one or more types of tangible, non-transitory computer-readable memory, such as random-access memory (RAM), read-only memory (ROM), flash memory, or a combination thereof. The modules can comprise processor-executable instructions that can be executed by processor 205.

The gift service server 105 also includes a data store 250 that can be used to store data used by the various modules stored in memory 220 and/or other components of the gift recommendation server.

The user interface module 222 can be configured to generate a user interface that allows users to interact with the gift collaboration system 100. The user interface module 222 can be configured to generate web-based content that allow users to view and interact with using a client device 120. Examples of some of the types of interfaces that can be generated by the user interface module 222 are described in detail below and illustrated in the figures.

The network module 226 can be configured to communicate with the network interface 260 of the server 105 to send and receive data over the network 115. The network interface module 226 can receive data to be sent over the network 115 from other modules in memory 220 and provide data received over the network 115 to other modules in memory 220.

The authentication module 234 can be configured to handle processing of the login credentials for existing users of the gift collaboration system or the affiliated social network service. New users can be directed to an account creation interface provided by the user interface module 222.

The invitation processing module 224 can be configured to receive requests to invite users to join a group. The user interface module 222 can provide an interface that allows a user to enter information that identifies one or more users to invite to participate in a group, and the user interface module 222 can provide the information to the invitation processing module 224. The invitation processing module 224 can receive various identifying information for the user, such as a username to the gift collaboration system, a username of a user of another social network service, an email address, or a mobile number for contacting the invitee via text message. If the invitee already has a user account with the gift recommendation service or with an affiliated social network service, the invitee can log into the gift recommendation service using those credentials to join the group for which the invitation was sent.

If only an email address or a mobile number was provided for an invitee, the invitation processing module 224 can transmit an email or text message invitation providing the invitee with opportunity to join the gift recommendation service. The invitation can include a web address for a new account creation page that allows the invitee to create an account with the gift collaboration system or to log into an existing account and link that account to the group. The invitation can also include a hyperlink that the user can click to be automatically redirected to a landing page on the gift recommendation service that allows users to create a new account. The invitation can also include a unique code that is associated with the invitation that will identify the invitee to the gift recommendation service.

The messaging module 232 is configured to allow users to post comments associated with gift ideas, a user's wish list, and/or regarding specific gift items associated with a particular gift idea or wish list. The message module 232 can be configured to allow user to post various types of content, including text, images, video content, audio content, etc. The posts can include hyperlinks to products or services offered by online retailers. Other members of the group may b be able to browse the comments posted by other users in the group and to post their own comments.

The messaging module 232 can also allow a creator of a group to designate administrators or moderators for the group and to designate whether the creator of the group should have access to the content posted to the group. In some instances, the creator of the group may not want to be part of the discussions or view the discussion. For example, a couple might create a group and invite their friends and family to participate in discussion regarding wedding gifts in that group. The couple could refer friends and family that ask them what they would like for a wedding gift to the group.

The seller interface module 228 provides an interface between the gift collaboration system and third party sellers. In some implementations, the seller interface module 228 can facilitate purchases of gifts from third-party sellers by transmitting purchase information to the third-party seller server 140 and/or payment information to the third-party seller server 140. The seller interface module 228 can also receive purchase confirmation information from the third-party seller 140. The seller interface module 228 can display the purchase confirmation information to users via a user interface provided by user interface module 222. In other implementations, the seller interface module 228 can be configured to display information about retailers that offer a gift for sale. For example, the seller interface module 228 can provide a list of retailers offering a particular item or service for sale that includes links to the retailers' online stores where a user can complete the purchase of the item or service.

The advertising module 236 can be configured to display targeted advertisements to users of the gift recommendation service based on the content associated with a particular group and/or other information associated with the receiver. For example, the advertising module 236 can be configured to select targeted advertising based on the attributes of gift ideas entered by members of the group and/or based on the discussions associated with various gift ideas and/or gift items associated with the group. The advertising module 236 can also be configured to select targeted advertising based on information associated with the receiver from other groups that are associated with the same receiver and/or from wish lists associated with the receiver.

The advertising module 236 can be configured to select the targeted advertising from one or more affiliated retailers offering products that are based on the attributes associated with gift items that the receiver may be interested in receiving. The advertising module 236 can be configured to conduct a search of content on offer from one or more affiliated retailers to identify products and/or services offered by the affiliated retailers that have attributes that may be of interest to the receiver. For example, the advertising module 236 can be configured to search web sites of the affiliated retailers to identify products on those web sites that may be of interest to the receiver and to display those products to members of the group. The advertising module 236 can be configured to scrape content from the web pages of the affiliated retailers and to reformat that content into a targeted advertisement that can be presented to members of the group.

The advertising module 236 can be configured to search for related advertising content when a member of a group creates a new gift item associated with a group by entering the URL of an item in the add gift item interface. The add gift item interface can be configured to scrape the content referred to by the URL and to present a formatted version of the content to the user. The advertising module 236 can also be configured to scrape the content from the URL, to conduct a search for other related items based on the scraped content, and to suggest those items to the user as well. The advertising module 236 can be configured to display the items that were discovered to members of the group and to provide an interface that allows member of the group to associate one or more of the gift items with the group and/or to claim or purchase the gift items for the receiver.

The recommendation module 240 can be configured to display information about recommended gift items to users. The recommendation module 240 can be configured to make recommendations based on the content of messages, gift ideas, and/or gift items posted to a group. Recommended gift items can be displayed with a ‘shopping’ icon that opens a modal dialog that shows different gifts matching the description from various retailers. Furthermore, a recommended gift item can be associated a group and/or associated with an existing gift idea associated with a group to allow members of the group to discuss the gift item and/or claim the gift item.

The suggestions made by the recommendation module 240 can also be based at least in part on past purchases made by the receiver and/or by others making purchases for the receiver. The recommendations can also be based at least in part on wish list information associated with the receiver or receivers associated with a particular group. The recommendation module 240 can select and rank suggested gift ideas based at least in part on current and/or past wish list ideas and the reputation of the member who suggested the gift item or gift idea. The reputation of the member of the group can cumulative and be based on feedback received by suggestions made by the member across multiple groups. The recommendations module 240 can also be configured to make recommendations based on demographic information associated with the receiver. For example, the receiver's age, sex, geographic location, and/or other information. The recommendations module 240 can also be configured to suggest recommendations for a receiver based on the receiver's “likes” on one or more social network services.

The search module 242 can be configured to allow user to find content, such a recipients, gift ideas, and groups by providing users with the ability to perform keyword searches of content included in gift collaboration system. The search module 242 can also be configured to provide keyword search capabilities to identify products offered by third party retailers that may be of interest of a user based on the keyword information provided by the user.

The social network integration module 244 is configured to provide an interface between third party social network services and the gift recommendation service. The social network integration module 244 can be configured to provide an interface that allows the social network server 130 to exchange information with the gift service server 105. In implementations where the gift recommendation service is integrated into content provided by the social network service, the social network integration module 244 can provide an interface that allows the social network service to access content on the gift service server 105 to be displayed to users of the social network service provided by social network server 130. In some implementations, the social network integration module 244 can also access information from the social network service provided by social network server 130. For example, in some implementations, the gift recommendation service can share login credentials with the social network service when the user attempts to login to the gift collaboration system with login credentials from the social network service.

The privacy module 246 is configured to allow users to configure privacy settings. For example, the privacy module 246 can be configured to allow a user creating a wish list to determine which users can view items from the list, and/or view and/or post messages associated with items on the list. The privacy module 246 can also provide an interface that allows users to manage their privacy settings. For example, a user can control who can see what profile information about that user, as well as who can communicate with the user through the gift recommendation service. The privacy module 246 can also control the privacy settings for a group. For example, the admin of a group can set the privacy settings of the group to be such that the group cannot be found through searching on the gift recommendation service or any public search engine. Alternatively, for example, the group privacy settings can be set such that the existence of the group, members, and content is able to be found through searching on the gift recommendation service or public Internet.

The purchasing module 230 is configured to allow users to purchase products or services as a gift that have appeared in advertisements or recommendations generated by the advertising module 236 and/or products or services that have been recommended by users of the service. The purchasing module 230 provides an interface that can capture payment information and other gift related information, such as delivery information (date and address), etc. The purchasing module 230 can provide payment and purchasing information to the seller interface module 228 if the gift or service is offered by a third party seller that is affiliated with the gift recommendation service.

The purchasing module 230 can also be configured to allow user to reserve gifts. For example, when a user clicks on a buy gift or claim gift button in shopping dialog, a gift can be temporarily reserved for a limited period of time (e.g., three days). A message can be posted to the discussion, and the gift is marked as reserved. An email can also be sent to the user who reserved the gift. In the email, the user (1) can claim the gift as bought, or (2) cancel the reservation (the gift has not been bought). The email can contain a link to the item. If user indicates that the purchase has been completed, additional message is posted to discussion that the purchase is complete. The purchasing module 230 can also provide a purchasing completion deadline that indicates a date and/or time by which the user must confirm that the user has completed the purchase or the gift item will be marked as unclaimed, which would allow other members of the group to claim the gift item

The purchasing module 230 can also provide an interface that allows multiple users to make contributions toward a collaborative gift, and once the amount required to purchase the gift has been contributed, the gift purchase can be completed. The purchasing module 230 can be integrated with the advertising module 236 to instruct the advertising module 236 to search for and display related items when a user claims and/or purchases an item for a receiver. For example, if the user claims a set of headphones for the receiver, the purchasing module 230 can provide attributes of the claimed item to the advertising module 236 to search for related items that the user might also wish to purchase for the receiver. For example, returning to the headphones example, the advertising module 236 might select advertisements for music related items, such as concert tickets or a gift card that could be used to purchase content from a music provider.

The feedback module 238 provides an interface that allows users, including the recipients of the gifts, to provide feedback about gifts. The feedback module 238 also can provide an interface that allows users to rate the suggestions provided by other users. Users having higher feedback ratings may be more “trusted” when making gift selections and be more likely to have their gift recommendations followed by other users. Highly ranked users may also be awarded virtual awards or points to recognize their contribution. These awards and points may be able to be exchanged for real-world benefit, such as discounts off of future purchases or could be assigned a cash value that can be applied toward the purchase of gifts.

The group module 248 is configured to allow a user to create new groups and to manage existing groups. The group module can be configured to allow a user to create a new group and to associate an intended receiver or receivers with the group. The group module 248 can also be configured to track which users are members of the group. The group module 248 can also be configured to keep track of which gift ideas and/or gift items have been suggested by members of the group. The group module 248 can also be configured to keep track of which gift ideas and/or gift items have been claimed and/or purchased by members of the group and to keep track of which members have purchased a gift. The group module 248 can also be configured to keep track of which gifts have been claimed as collaborative gifts. The purchasing module 230 can be configured to collect contributions toward gifts that are designated as collaborative gifts and to notify the group module 248 when the contribution goal associated with a gift item is reached and the purchase of the gift completed.

Receiver module 252 can be configured to allow a user to create a wish list that includes gift items and/or gift ideas that the receiver would be interested in receiving. The receiver module 252 can be configured to collect wish list information from the user including the name of items, the price of items, the URL of one or more online retailers offering the item for sale, a description of the desired item, and/or other information. The receiver module 252 can also be configured to store characteristics associated with a particular recipient. For example, the receiver module 252 can be configured to store a shipping address associated with a receiver. The receiver module 252 can also be configured to store other attributes associated with the receiver, such as preferred clothing size, colors and/or styles that the receiver prefers. The attributes associated with the receiver can be collected from the receiver and/or other members of the group. The attributes associated with the receiver can also be derived based on past purchases by the receiver or for the receiver. The attributes can also be derived from one or more wish lists associated with the receiver. The receiver module 252 can also be configured to identify existing receivers to be associated with a new group being created. For example, the receiver module 252 can attempt to match an existing receiver (or other non-receiver user registered with the gift collaboration system) to a newly created group based on information provided about the receiver by the user creating the group, such as the receiver's name, email address, or other identifying information. The receiver module 252 can be configured to match information provided by the receiver with people in the contact list and/or social network connections of the user creating the group to determine one or more candidates that the user may have intended as the receiver. The receiver module 252 can be further configured to compare attributes associated with the candidate receivers with receivers (and/or other users) already identified in the system. If match is found, the groups associated with that receiver and the gift ideas and/or gift items associated with those groups can be used by the receiver module 252 to identify attributes of gift items that the receiver may be interested in receiving. The receiver module 252 can also be configured to use any wish lists associated with the receiver to identify attributes of gift items that the receiver may be interested in receiving. The receiver module 252 can provide these attributes to the recommendation module 240, which can be configured to use these attributes to attempt to identify one or more gift ideas offered by online retailers. The receiver module 252 can also be configured to receive characteristics of the receiver from one or more members of a group associated with the receiver. For example, members of the group might know a shipping address for the receiver and/or specific likes and dislikes of the receiver.

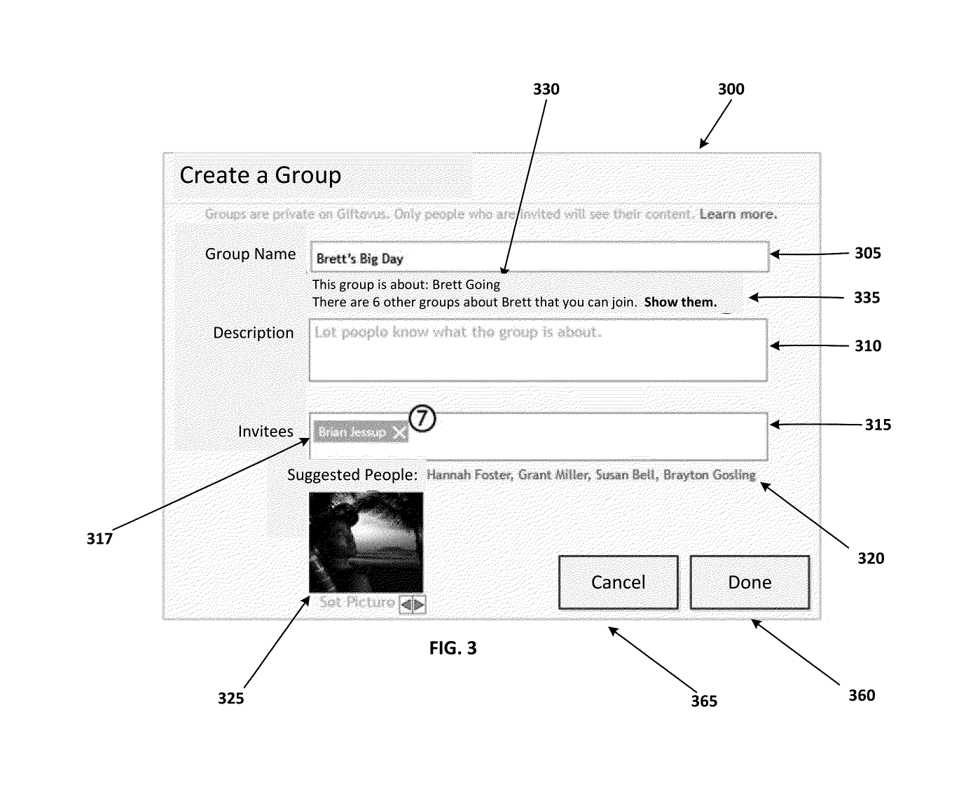

FIG. 3 is an example of a create group interface 300 that can be provided by the gift collaboration system illustrated in FIG. 1. The create group interface 300 provides a user interface that allows a user to create a new group within the gift collaboration system. The create group user interface 300 can be generated by the user interface module 222 and can provide data to the invitation processing module 224. Data collected on by the create group interface 300 can also be stored in the data store 250.

The group can be associated with a receiver who is the intended recipient of a gift. The creator of the group can identify the intended receiver of the gift and can invite others to participate in the group. Participants in the group will be able to interact with other members of the group via the gift collaboration system to suggest and discuss potential gifts for the receiver, as well as to claim and/or contribute toward gifts for the receiver.

The create group interface 300 can include fields for capturing various information about the group. For example, the create group interface 300 illustrated in FIG. 3 includes inputs for a group name field 305, a group description field 310, group invitees field 315, suggested group members 320, a group picture 325, suggested receiver 335, and suggested other groups. The create group interface 300 also can include a cancel button 365, and a done button 360.

The group name field 305 can be used input a name to be associated with the group being created. The group name can be used to identify the group and can be included in invitations to invitees that are asked to join the group. The invitations can be sent in various forms, such as via email or text message.

The group description field 310 allows the user to enter an optional description for the group being created. The description of the group may be used in several ways. For example, the description of the group may be included in invitations sent to invitees. The description of the group can also be used to facilitate searching for groups by the search module 242. The search module 242 can attempt to match search terms to words or phrases included in the description of the group. The description of the group can also appear in a “cell” that displays the description of the group on the group interface page described below.

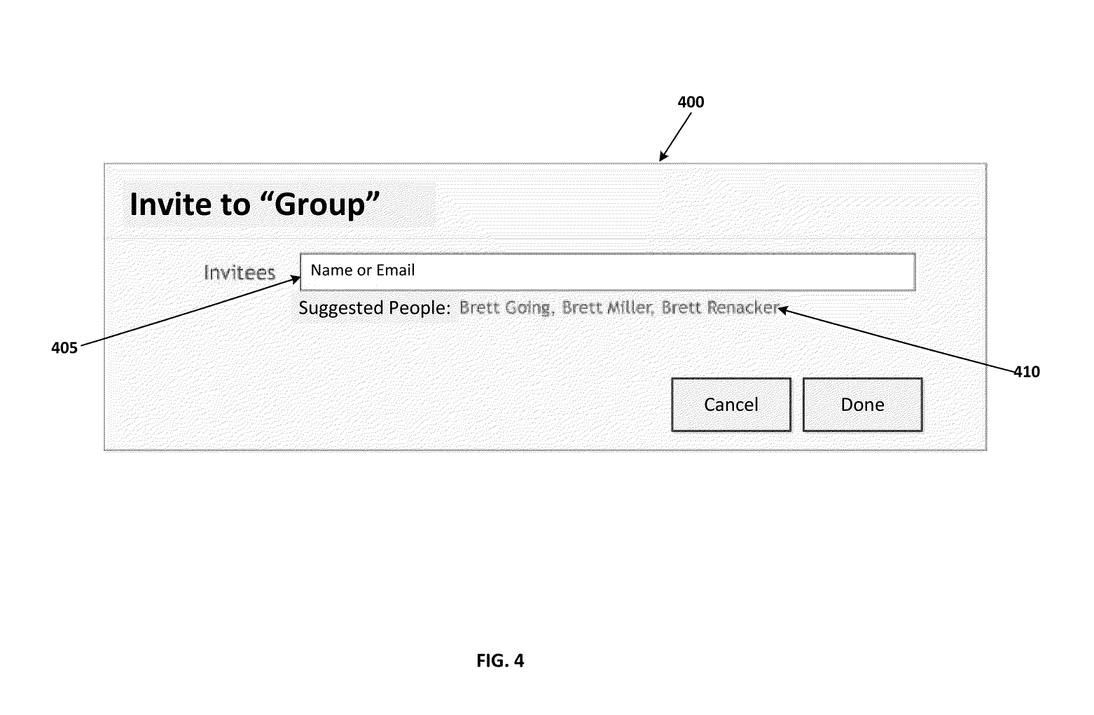

The group invitees field 315 can be used to enter invitees to be invited to join the group. The group invitees field 315 can be configured to allow the user to enter the usernames and/or the full names (e.g., first and last names) of other users to be invited to join the group. The group invitees field 315 can also have a search option (not shown) that activates the “invite to group” interface 400 illustrated in FIG. 4. The invite to group interface can include an invitee field 405 where the name of an invitee, an email address, or other identifying information associated with an invitee can be entered. For example, invite to group interface 400 be configured to allow a user to search for invitees by username, first and/or last names, or other information associated with the invitees, such as other groups to which the invitees belong. The invite to group interface 400 can also be configured to search for invitees by social network connections as well. For example, the group interface can be configured to search for mutual social network connections between the user creating the group and other members of the group and/or the intended recipient associated with the group. The user interface module 222 can be configured to receive the information entered by the user in the invitee field 405 and search for matches in the user's friends in the gift collaboration system, in the user's contacts on one or more email systems, and optionally on one or more social networks.

Suggested receiver 335 identifies who the group is about. When a group is first created, it may not yet have a receiver associated with the group. The suggested receiver 335 section can be configured to display a list of possible receivers that the user creating the group knows. The list of suggested receivers can be selected from friends of the user on one or more social networking sites and/or from a contact book that includes people that the user knows. The contact book might be extracted from one or more email systems in which the user has contact information. The gift collaboration system can be configured to narrow the list of suggested receivers 330 based on information entered in the group name field 305. In the example illustrated in FIG. 3, the user has entered “Brett's Big Day” into the description field, and the gift collaboration system has selected a list of suggested receivers that have the name “Brett.” In the example illustrated in FIG. 3, the names included in the list are a hyperlink that, when activated, causes the selected entry from the suggested receiver to be associated as the intended Receiver for the group. The suggested receiver 335 can also include a link or other control mechanism that allows the user to indicate that the suggested receiver 335 does not include the intended receiver. For example, in FIG. 3, the suggested receiver 335 includes a link “Other?” that the user can click to initiate a search for other receivers.

Suggested other groups link 335 can be used to suggest other groups that the user might join rather than creating a new group. Once a Receiver associated with the group has been identified, the search module 242 can search for other existing groups that have the same Receiver. The user can activate the show other grounds link 335 to cause the user interface module 222 to display a group list interface that displays details of existing groups. The group list interface can include controls that allow the user to join one or more of the exiting groups or return to the create group interface 300 where the user can create a new group if desired.

Returning now to FIG. 3, the create group interface 300 can include a set of suggested group members 320 illustrated below the group invitees field 315. The set of suggested group members 320 might be selected from a list of contacts associated with the user or a list of “friends” associated with the user on one or more social networking sites. The user can click on one or more of the suggested group members 320 to add them to the list of invitees included in the group invitees field 315.

The create group interface 300 can include a group picture 325 to be associated with the group. The create group interface 300 can display the group picture 325 as a thumbnail of an image selected to be associated with the group. The group picture 325 can be displayed with the group name on the invitations and on various group related interfaces within the gift collaboration system. The create group interface 300 can be configured to display an icon indicating that no picture has been selected if the user has not selected a group picture 325. Clicking on the icon or the thumbnail can launch a user interface that allows the user to select an image from their computer, from an online image, by providing the Uniform Resource Locator (URL) or Uniform Resource Identifier (URI) where the image can be located online.

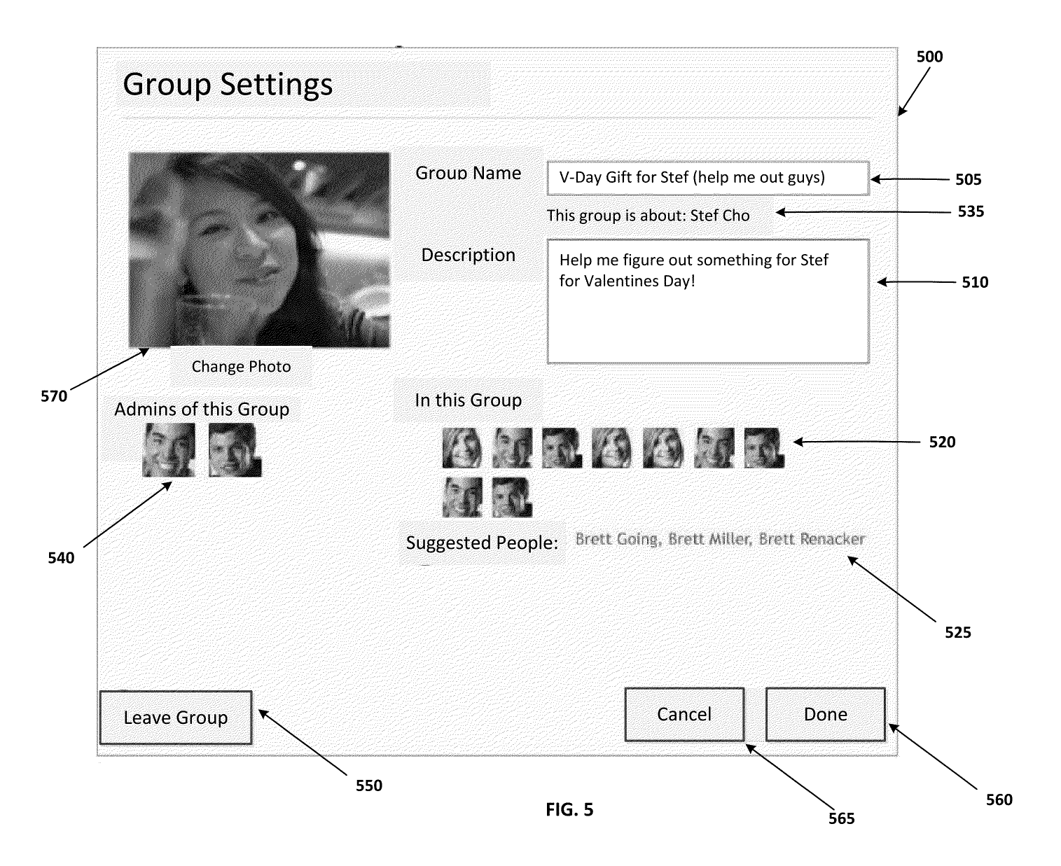

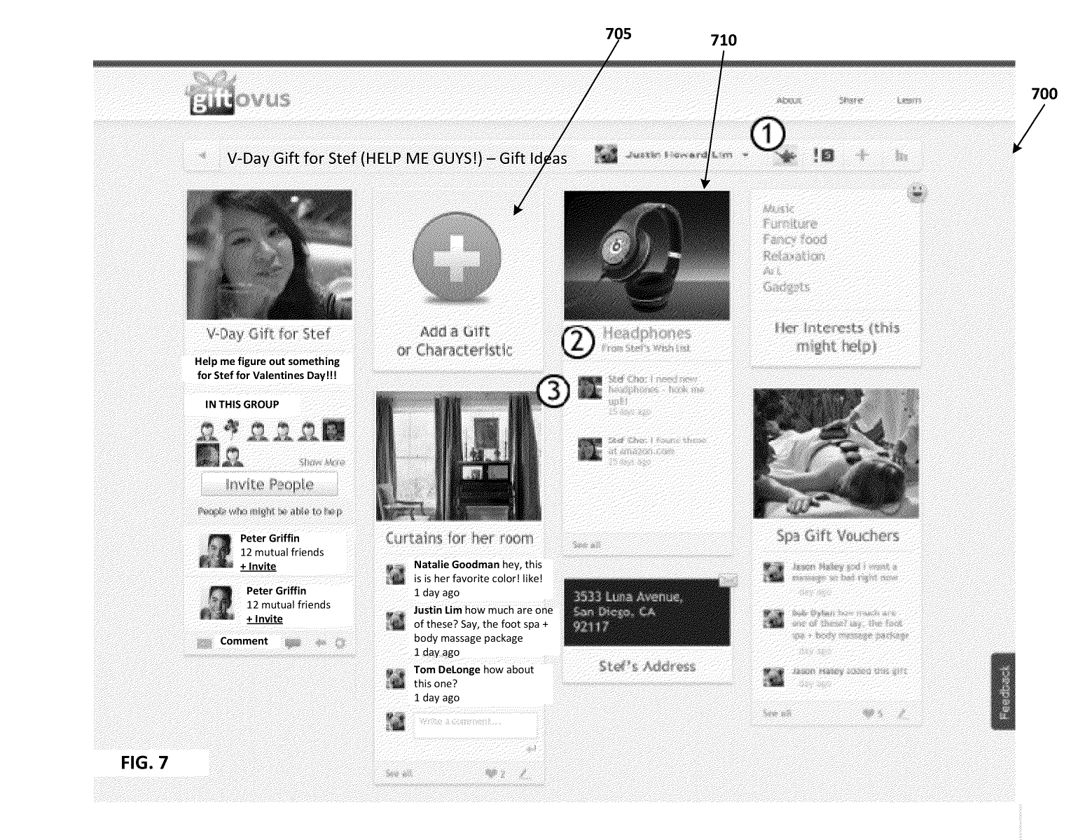

FIG. 5 is an example of a group settings interface 500 that can be provided by the gift collaboration system. The group settings interface 500 provides an interface where authorized users can view and/or modify settings associated with a group. A group can be created using the create group interface 400 described above. The group settings interface 500 can be accessed from the group interface 700 illustrated in FIG. 7 and described in detail below.

The group settings interface 500 includes a group name field 505, a group description field 510, a group picture 570, group administrators information 540, receiver information 530, group member information 520, suggested group members 525, leave group button 550, done button 560, cancel button 565.

The group name field 505 displays the name of the group and allows the name of the group to be edited. The name of the group displayed in the group name field 505 may be the group name that was entered in the group name field 305 of the create group interface 300 if the name of the group has not been changed since it was created. Otherwise, the group name displayed can be the current name associated with group.

The group description field 510 displays a description of the group and allows the description of the group to be modified or deleted. The description of the group displayed in the group description field 310 may be the group description that was entered in the group description field 310 of the create group interface 300 when the group was created. Otherwise, the group description displayed will be the current description associated with the group.

The group picture 570 can display a photograph associated with the group. The group picture 570 can be configured to initially display the group picture selected using the group picture 325 icon included on the create group interface 300. The group settings interface 500 can be configured to display an icon in place of a photograph indicating that no picture has been selected if the user has not selected a group picture 570. Clicking on the icon or the thumbnail can launch a user interface that allows the user to select an image from their computer, from an online image, by providing the Uniform Resource Locator (URL) or Uniform Resource Identifier (URI) where the image can be located online. The user can also optionally delete a photograph associated with the group, if desired.

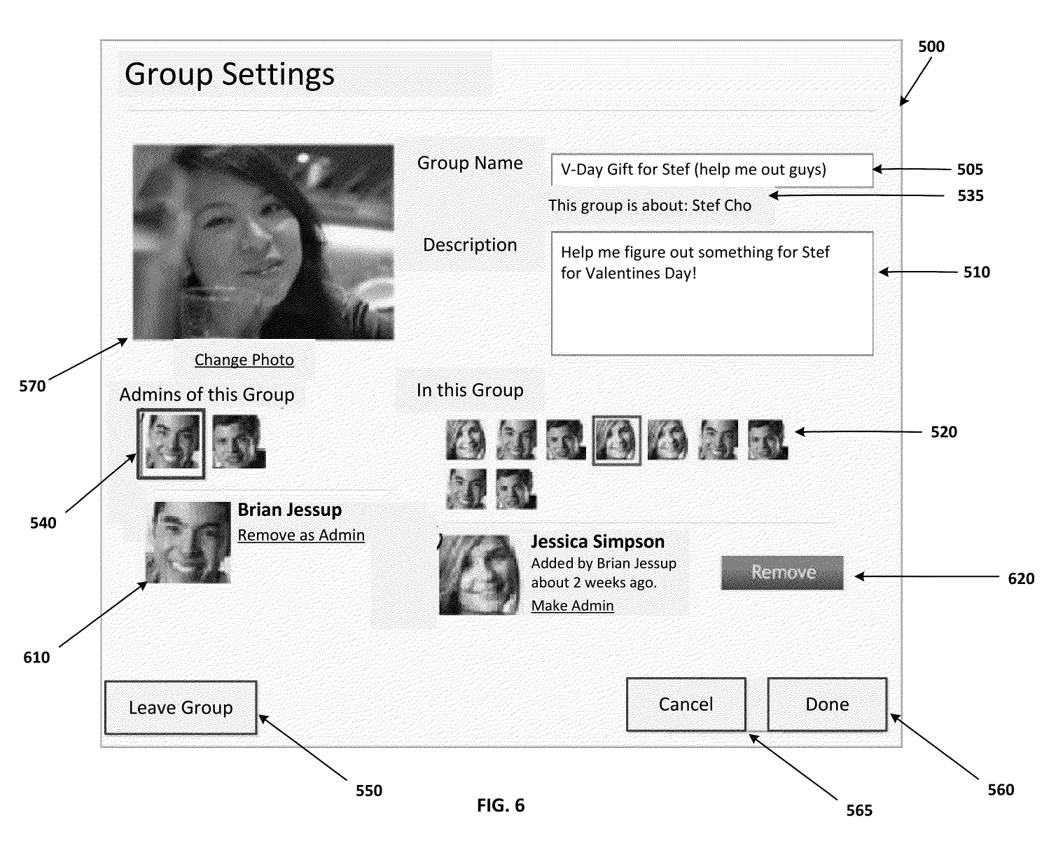

The group administrators information 540 displays a list of administrator users associated with the group. The administrators may include the user who created the group and may include one or more other users that have been selected to be an administrator by an administrator of the group. FIG. 6 illustrates an example of the interface of FIG. 5 where one of the administrators has been selected, and the administrator information 610 is displayed. The administrator information 610 includes an option where the selected administrator can be removed from the group. According to some implementations, a user must be an administrator to add or remove an administrator from a group. In some implementations, the user administrator that created the group is the only user that can add or remove administrators from a group.

Returning now to FIG. 5, the receiver information 535 displays the name and or other information of the receiver associated with the group. The receiver information 535 can display the suggested receiver 335 information that was entered in the create group interface 300. The receiver is the intended recipient of one or more gifts and is the subject of the various discussions and interactions associated with the group. The receiver information 530 may be modified by authorized users. For example, in some implementations, the administrators of the group may be able to change the intended recipient of a group. For example, if a group is created for a bride to be, an administrator might add the groom to be as a second receiver or may replace the bridge with the groom as the Recipient for the group.

The group member information 520 can display information about the members of the group. The group member information 520 can be configured to display the names of the members of the groups, a picture of the members of the group, and/or other information that can be used to identify group members. The group member information 520 can display the users who were invited to join the group in the group invitees field 315 of the create group interface 300 and accepted the invitation to join the group.

The suggested group members 525 can be configured to display other people who may be interested in joining the group. The suggested group members 525 might include people from a list of contacts associated with the user editing the group or a list of “friends” associated with the user on one or more social networking sites. The suggested group members 525 may also include friends and/or contacts associated with other members of the group. The user can click on one or more of the suggested group members 525 to cause the user interface module 222 to instruct the invitation processing module 224 to generate an invitation for the selected group members. Those who accept the invitation can be added to the group and if they are currently not a user of the gift collaboration system, a new user account can be created for them upon accepting the application to join the group.

FIG. 6 illustrates an example of a group member in the group member information 520 being selected. In this example, the suggested group members information 525 is replaced with selected user information 620. The selected user information can provide additional information about the user, such as who invited the user to be part of the group, when then user was invited to join the group or when the user actually joined the group. The selected user information 620 can also provide controls that allow the user to be removed from the group, to be made into an administrator for the group, and/or other changes associated with the user. As described above, in some implementations only administrators can add or remove administrators from a group. In some implementations, only administrators can add or remove members from the group.

The leave group button 550 allows the user to leave a group. The user can activate the leave group button 550 and the user will be removed from the group. If the user of the group is the only administrator associated with the group, the group can be removed from the gift collaboration system.

The done button 560, when activated, will save any changes that were made by the user, if the user is authorized to make changes to the group information. The cancel button 565 allows the user to cancel any changes that were made to the group data without saving the updates.

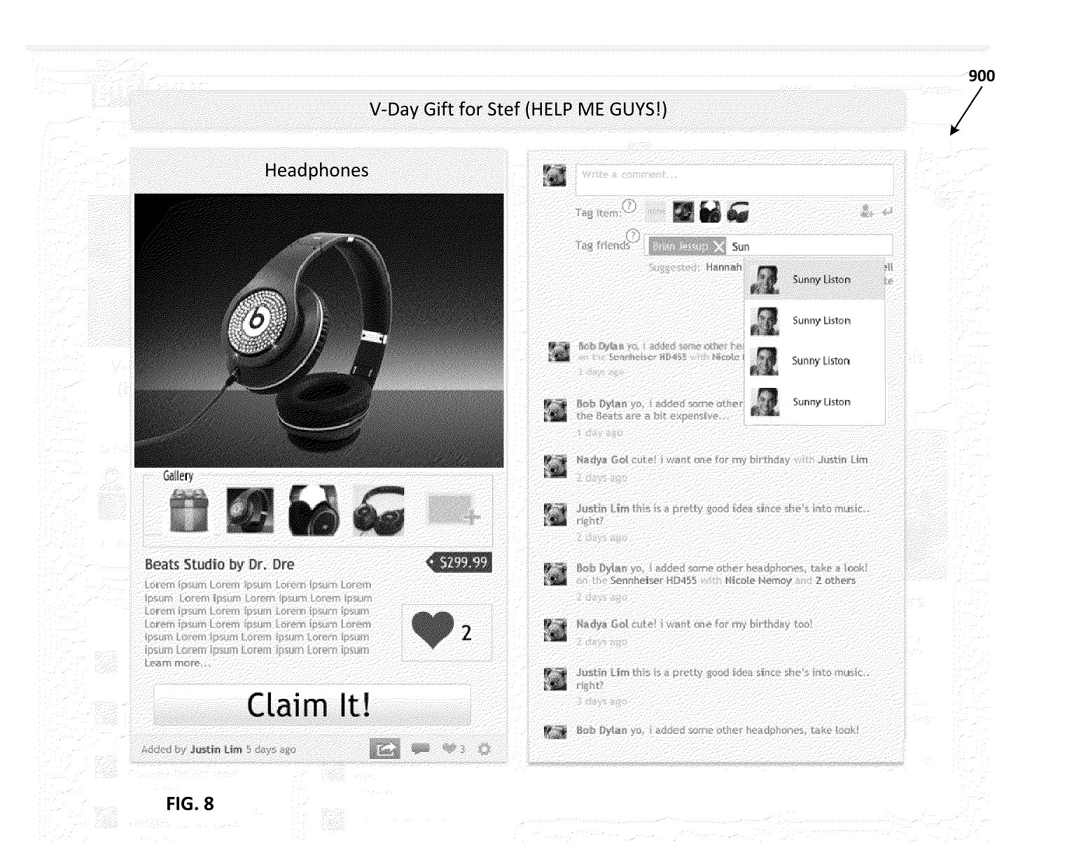

FIGS. 7-19 illustrate aspects of a group view interface that allows members of the group to interact with one another, to suggest, add, and/or claim gifts, and access and/or provide information related to the receiver of a gift.

FIG. 7 illustrates an example of a group interface 700 that allows members of the group to interact with the gift collaboration system. One aspect of the gift collaboration system is allowing users to associate gift ideas for a particular receiver with a group. The gift ideas may relate to a specific product or may be conceptual (e.g., “new shoes), and the group interface 700 provides a “gallery” view of gift ideas that have been created and associated with the group. The group interface 700 can also display additional information about the Recipient, such as the Recipient's address and the Recipient's interests, as part of the gallery.

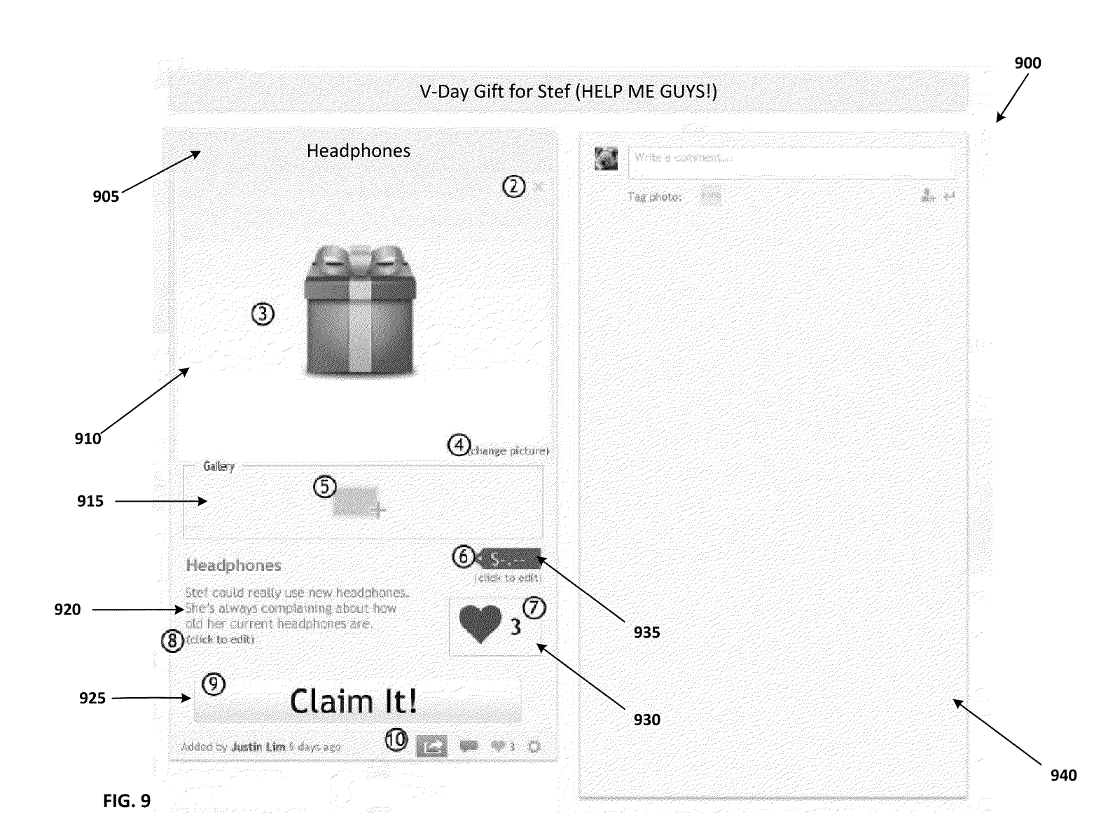

FIG. 7 includes an add gift or characteristic icon 705 that, when clicked or otherwise activated by a user, causes the gift collaboration system to display the create gift idea interface illustrated in FIG. 9 to be displayed. The gift idea interface is described in greater detail below. Returning now to FIG. 7, the group interface 700 can also be configured to display gift ideas that have already been associated with the group. For example, gift idea 710 has been added from the receiver's wish list. Gift ideas can be added by members of the group or generated from a wish list created by the Recipient associated with the group.

FIG. 9 illustrates an example of a gift idea interface 900. The gift idea interface 900 can be configured to allow users to suggest gift ideas for a receiver that can be associated with the group. The gift idea interface 900 can also be configured to allow users to suggest and associate specific gift items with the gift idea that members of the group can discuss, claim, and/or purchase for the receiver. The gift idea and the suggested gift items can provoke discussion amongst the members of the group and may inspire group members to suggest additional gift ideas and/or gift items that in turn may be discussed, claimed, and/or purchased by the group members. The associations between gift idea and gift items and the associations between the receiver and gift ideas and/or gift items can be used by the recommendation module 240 to improve the recommendations made for the receiver associated with the group and/or for other receivers. For example, if users associate particular gift items (e.g., a particular brand and model of camera) with a particular gift idea (e.g., “point and shoot camera”), the recommendation module 240 of the gift collaboration system can be configured to take into account these recommendations when selecting products to recommend when a related gift idea is added to a group in the future. For example, the recommendation module might select the recommended brands and/or models of camera associated with the “point and shoot camera” gift idea and suggest those brands and/or models or camera for other related gift ideas (e.g., “digital camera” or “camera”). The recommendation module 240 can also be configured to give more weight to items that have been suggested as gift items than to other items that may be available from affiliated retailers when determining items to be recommended to a user.

The gift idea interface 900 provides an example of one type of interface that may be provided by the gift collaboration system that allows users to add gift ideas, associate gift items with gift ideas, and claim and/or purchase gift items. Other implementations of the gift idea interface may capture additional and/or different information than is discussed herein with respect to the gift interface 900.

The gift idea interface 900 can include a gift title 905. The gift title 905 can be edited to change the text that describes the gift idea. In the example illustrated in FIG. 9, the gift idea is for headphones and the gift title 905 currently display the text “Headphones.”

The gift idea interface 900 can include a gift idea picture 910. The gift idea picture 910 can be represented by a gift box icon or other icon if no picture has been associated with the gift idea. The gift idea interface 900 can be configured to allow the user to change the gift idea picture 910 by clicking on the select picture control 915, which causes the user interface module 222 to display a picture selection interface. The picture selection interface can be configured to allow the user to select a picture from the user's computer or from a location on the Internet, such as a web page, by entering the Uniform Resource Locator (URL) or Uniform Resource Indicator (URI) of an image of the gift item.

The gift idea description 920 can be used to provide a description of the gift idea. The user can edit the information included in the gift idea description 920 and the information included in the gift idea description 920 can also be displayed with the gift item in the gallery view illustrated in FIG. 7.

The comments section 940 allows users to enter comments about the gift idea. For example, a user might enter information about the size, color, or other attributes of a gift. The comments section 940 allows users in the group to collaborate in the gift giving process by engaging in conversations about the gift idea. Other users from the group who access the gift idea interface 900 for that gift are able to view the comments that have been posted for the gift idea and post their own comments to encourage collaboration among the group members.

The gift idea interface 900 can be configured to allow a member of the group to “tag” or identify a person that is mentioned in a message in the comments section 940. The message may be created by the member of the group who is tagging the person or may have been posted by another member of the group. The person being tagged might be a user of the gift collaboration system or may be a person who is not yet a member of the gift collaboration system. The gift idea interface 900 can be configured to collect various information identifying the tagged person, such as their name, an email address or other contact information, and usernames associated with the person in the gift collaboration system and/or one or more social networking services. The gift idea interface 900 can be configured to interface with the invitation processing module 224 to send an invitation to join the group to the tagged person. If the tagger person is not yet a member of the gift collaboration system, the invitation processing module 224 can be configured to send an invitation to the tagged person inviting that person to set up an account with the gift collaboration system. Similar tagging logic can be implemented in other interfaces of the gift collaboration system where members of the group may post messages. The tagging logic described herein can also be implemented in a social networking service or other electronic communications environment where users of the service can post messages and/or communicate with other members. For example, a first user of a social networking service can tag a second user included in a post to a third user's page in a social networking service, and the social networking service can be configured to collect information identifying the tagged person, and to invite the tagged person to join the social networking service the tagged person is not a member of the social networking service or to associated the collected information with the tagged user if the user is already a member of the social networking service.

The gift price 935 can be used to set a price for the gift if a price is known or to enter an estimated or desired price for the gift idea if a specific price for the gift idea is not known. For example, if a creating or editing the gift idea illustrated in FIG. 9 knows the price of a particular set of headphones that he or she would like to recommend, the user can enter a price here. The user can also enter a desired price that the user would like to spend for the gift, e.g. $100.

The “love” icon 935 allows user to click the icon to allow the user to express that user favorable view's the gift idea. The love icon 935 can include a counter that displays how many members of the group “love” the gift idea. The “love” icon 935 and/or the counter of how many members of the group love the gift idea can also be displayed as part of the information about the gift idea that is included in the gallery view illustrated in FIG. 7.

The gift idea interface 900 can also include a claim gift idea button 925 that allows the user to indicate that they are claiming the gift idea for the receiver. By claiming the gift idea, the user can indicate that he or she would like to purchase or contribute to a gift related to the gift idea for the receiver.

The gift idea interface 900 can be configured to include a copy gift idea button (not shown) that can be used to make a copy of a gift idea. Clicking on the copy gift idea button causes the gift collaboration system to copy at least a subset of the information for the gift idea into a new gift idea record associated with the group and populate the gift idea interface 900 with the information in the new record. According to some implementations, the votes and/or comments associated with a gift idea would not be copied to the newly created gift idea when a copy of a gift idea is created.

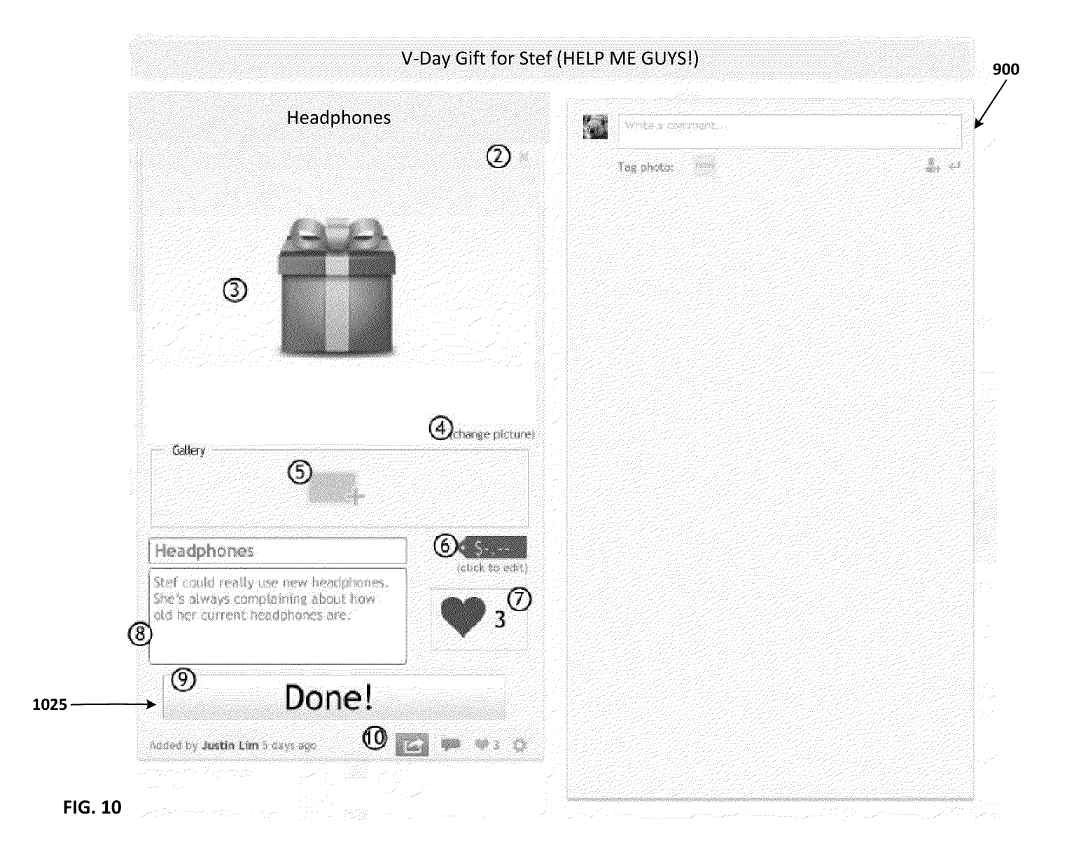

FIG. 10 illustrates an example of the gift idea interface 900 where the claim gift button 925 has been replaced with a done editing button 1025 when the user is in the process of editing information associated with the group. For example, if the user clicks on the gift idea description 920 and begins changing the text, the gift idea interface 900 can be configured to display the done editing button 1025 that allows the user to confirm the changes to the information associated with the group. In alternative implementations, the gift idea interface 900 can be configured to display the done editing button 1025 in addition to the claim gift idea button 925, and the gift idea interface 900 may be configured to disable the claim gift idea button 925 while the gift idea information is being edited by the user. The gift collaboration system can also be configured to allow other users to view a gift idea while another user is editing the gift idea information, but the gift collaboration system can be configured to disable the claim gift idea button 925.

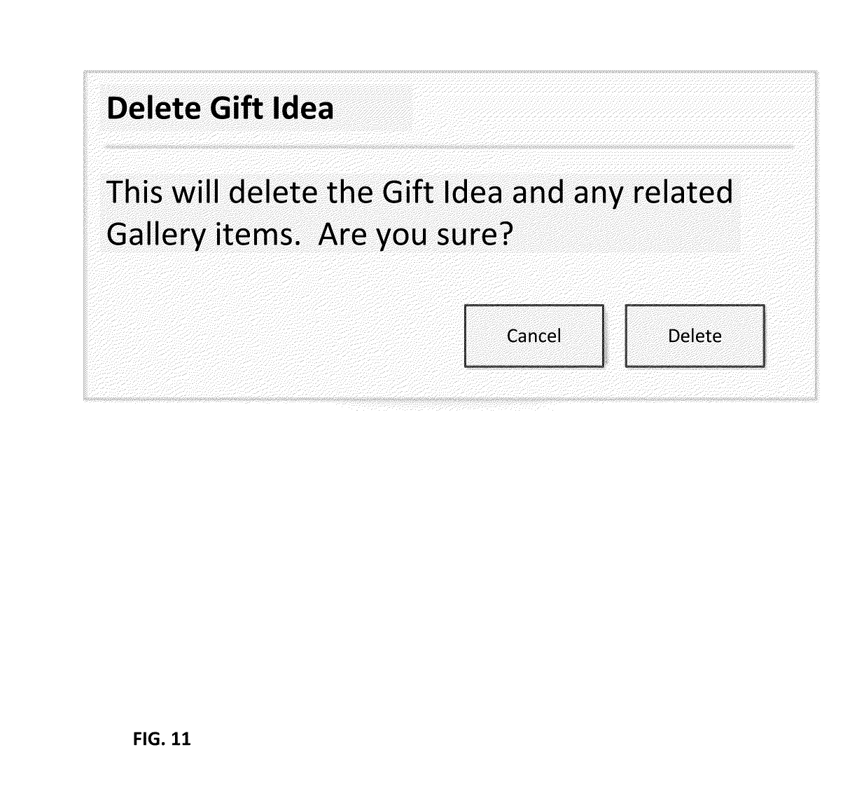

FIG. 11 illustrates an example of a delete gift idea interface 1100 that can be displayed to a user if the user selects a delete gift idea on the gift idea interface 900. The delete gift idea interface 1100 can prompt the user to confirm whether the user would like to delete the gift idea. The user interface module 222 can be configured to route the user back to the gift idea interface 900 if the user elects to cancel the deletion of the gift idea. The user interface module 222 can also be configured to route the user back to the group interface 700 if the user elects to delete the current gift idea. The gift collaboration system can be configured to only allow administrators to delete gift ideas. In some implementations, a user who created a gift idea can also be authorized to delete the gift idea.

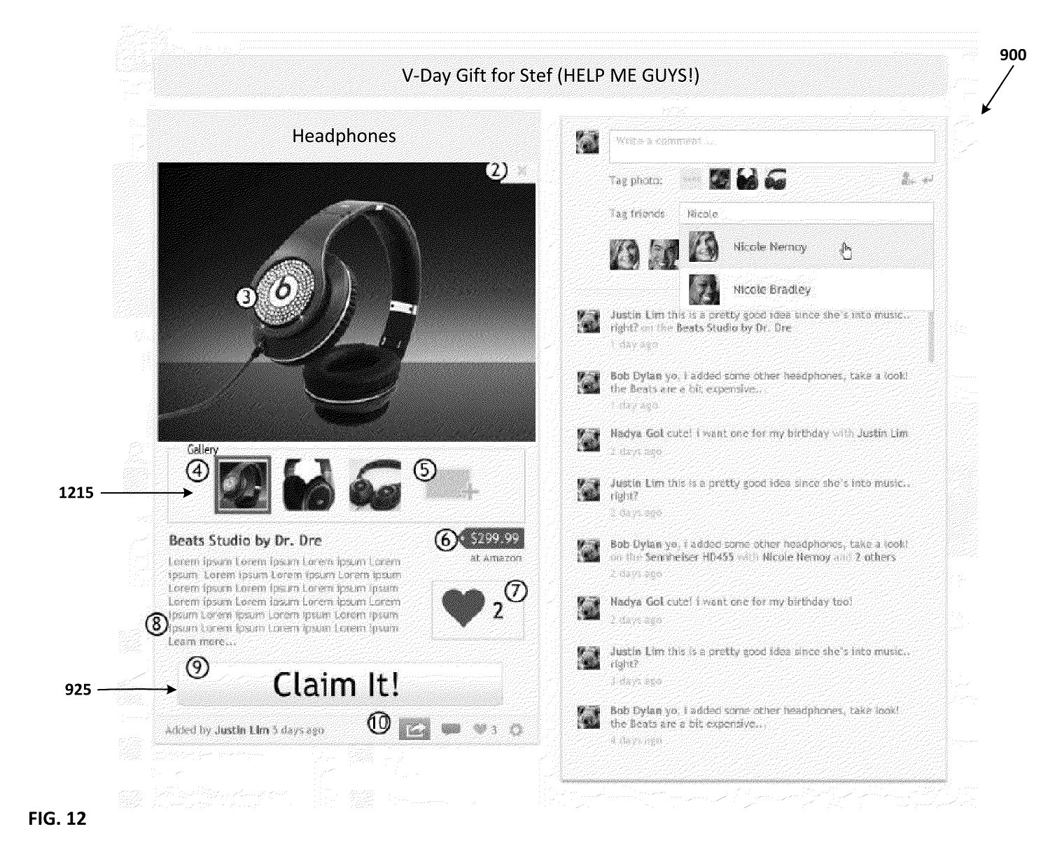

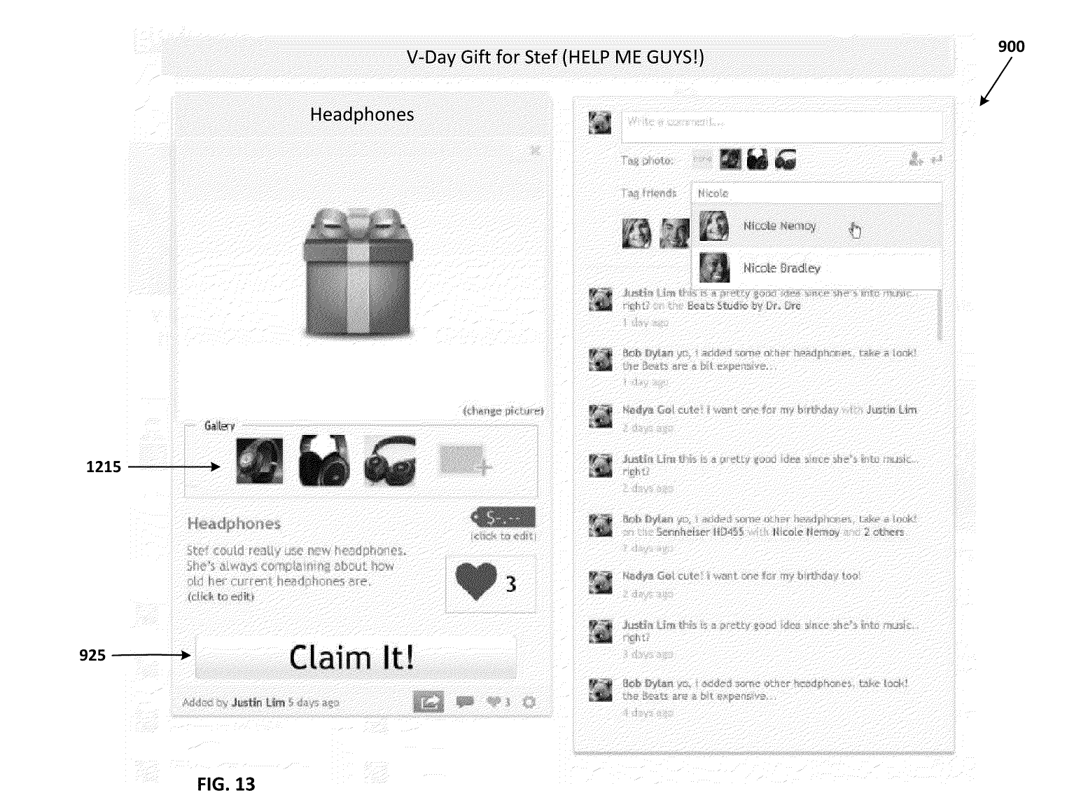

FIG. 12 illustrates an example of the gift idea interface 900 where the gift idea includes gallery items 1215. The gallery items 1215 represent items associated with a gift idea that one or more members of the group have suggested as items that may be potentially selected for purchase for the recipient associated with the group. In some implementations, the gallery items can be sorted by how much group members “love” the gallery items. For example, the gallery items can be ordered based on the number of members of the group that indicated that they “love” the gallery item by clicking the love icon 935 included on the gift idea interface 900. In the example illustrated in FIG. 12, the left-most gallery item has been selected from the gallery items 1215, and a picture associated with the selected gallery item is displayed in the gift idea picture 910 area of the gift idea interface 900. FIG. 13 illustrates an example of the gift idea interface 900 where none of the gallery items 1215 are selected. As can be seen from FIG. 13, the gift idea interface 900 can be configured to display the gift idea picture 910 (if any) associated with the gift idea if no gallery item 1215 is selected.

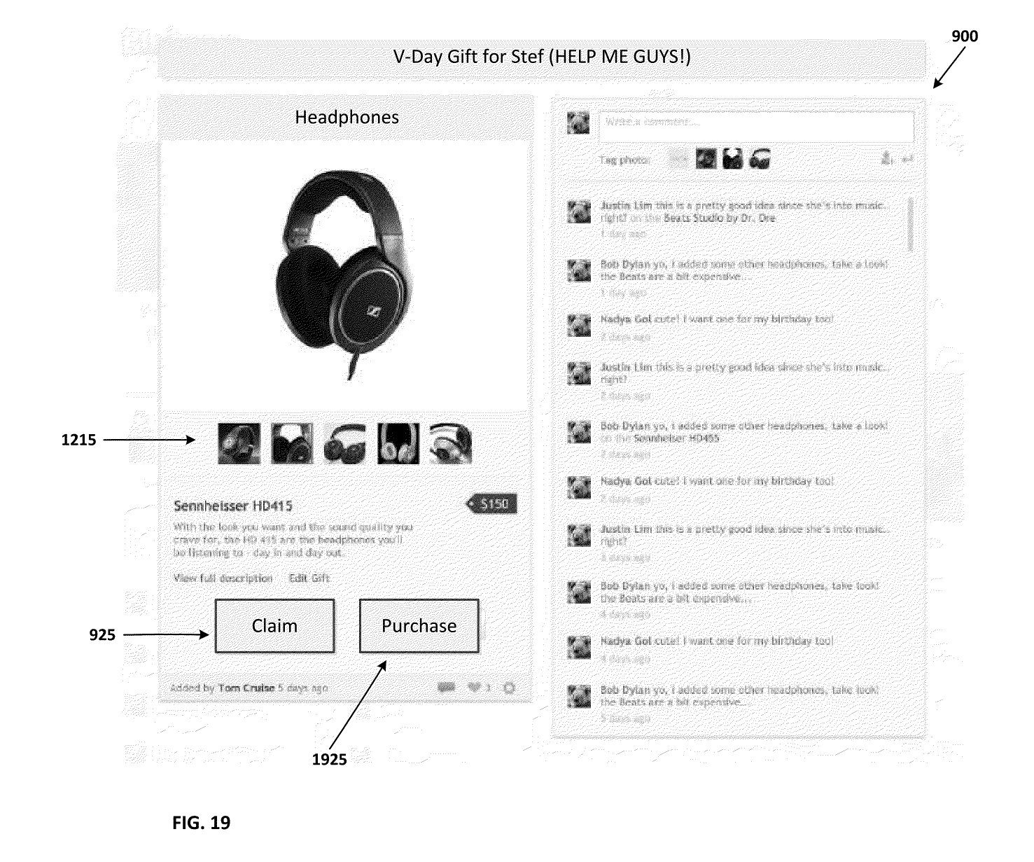

The gift price 935 can also be updated to display a price associated with the selected gallery item. As described above with respect to FIG. 9, a price may be manually entered by a group member. In some implementations, a gallery item 1215 can be linked to an item for sale on an external website. Where the gallery item 1215 is linked to an item for sale on an external website, the gift price 935 can be updated to reflect the price of the linked item on the external website. The gift price 935 can also include a label that indicates that the gallery item is linked to an external site and the label can include the name or another identifier associated with the external website. FIG. 19 illustrates and example of the gift idea interface 900 where five gifts have been added to the gallery items 1215. FIG. 19 also illustrates a variant of the gift idea interface 900 where the a purchase gift button 1925 is included in addition to the claim gift idea button 925. The purchase gift button 1925 provides can be configured to claim the gift and to cause launch a purchase interface that allows the user to complete the purchase transaction of the gift from an affiliated online retailer.

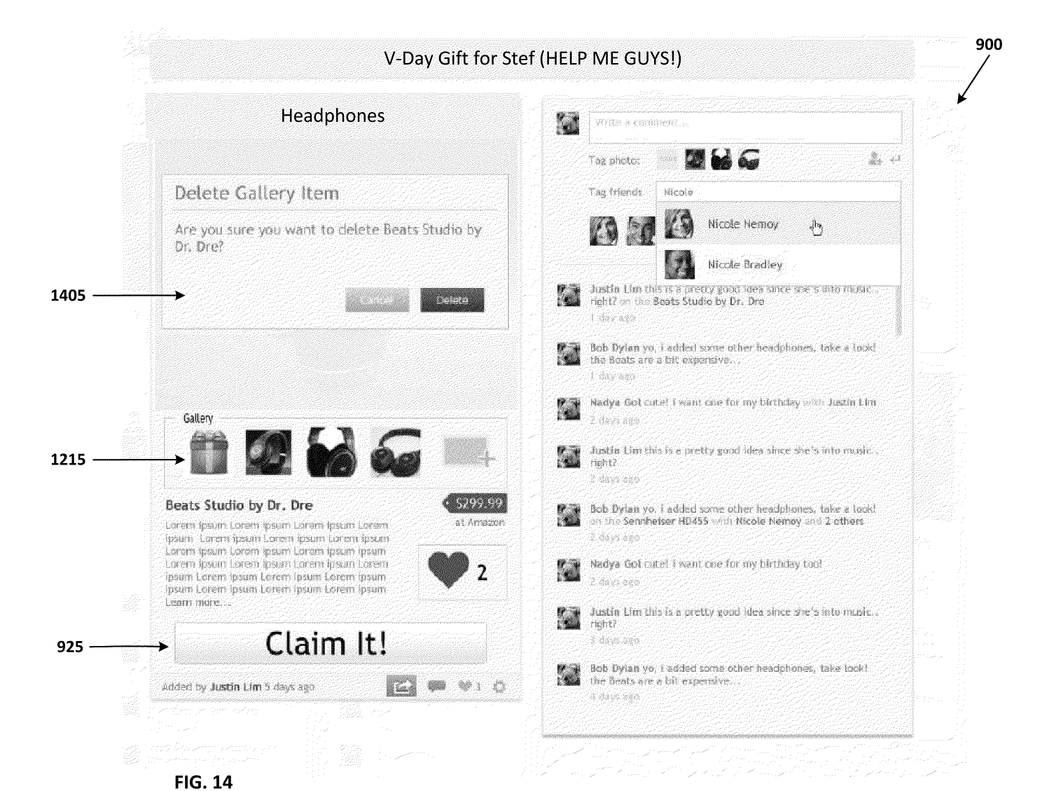

FIG. 14 illustrates an example of the gift idea interface 900 displaying a delete gallery item interface 1405. A user who added the gallery item or an administrator associated with the group can delete an item from the gallery items 1215. For example, the gift idea interface 900 can be configured to include a delete button (not shown) that allows a user to select and item from the gallery items 1215 and click the delete button to remove the gallery item from the gallery items 1215.

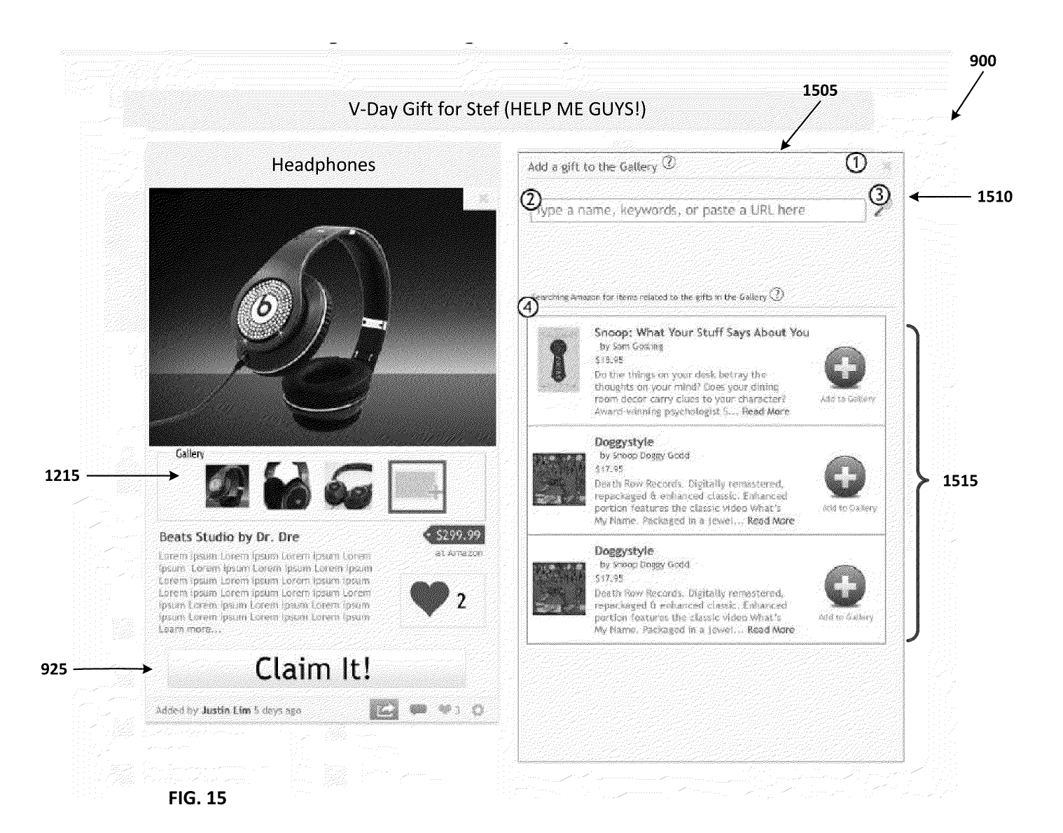

FIG. 15 illustrates an example of the gift idea interface 900 displaying an add item to gallery interface 1505 that can be used to add an item to the gallery items 1215. The gift idea interface 900 can be accessed by clicking on a gift idea displayed by the group interface 700. The add item to gallery interface 1505 can include item search criteria field 1510. The user can enter a name of a product, keywords associated with a product, and/or a URL of a website where a product is available online. The user interface module 222 can pass the search criteria to the search module 242, and the search module 242 can search for products associated with the search criteria entered by the user. The search module 242 can be configured to conduct a search on one or more online merchant sites for products associated with the search criteria. FIG. 19 illustrates an example of the gift idea interface 900 where five gifts have been added to the gallery items 1215.

Products matching the search criteria can be displayed in the search results section 1515. The search results section can include various details associated with the products that match the search criteria, such as a product image, product description, price, and seller information. The search results section 1515 can include controls that allow a user to add one or more of the search results to the gallery items 1215.

In some implementations, a default set of search criteria based on the gift idea title 905 and/or the gift idea description 920 can be used to conduct a product search and to provide a default set of search results to populate the search results section 1515 if no search criteria have been entered in the search criteria field 1510. The default set of search criteria can also be based on the keywords associated with items that have already been added to the gallery items 1215 (if any).

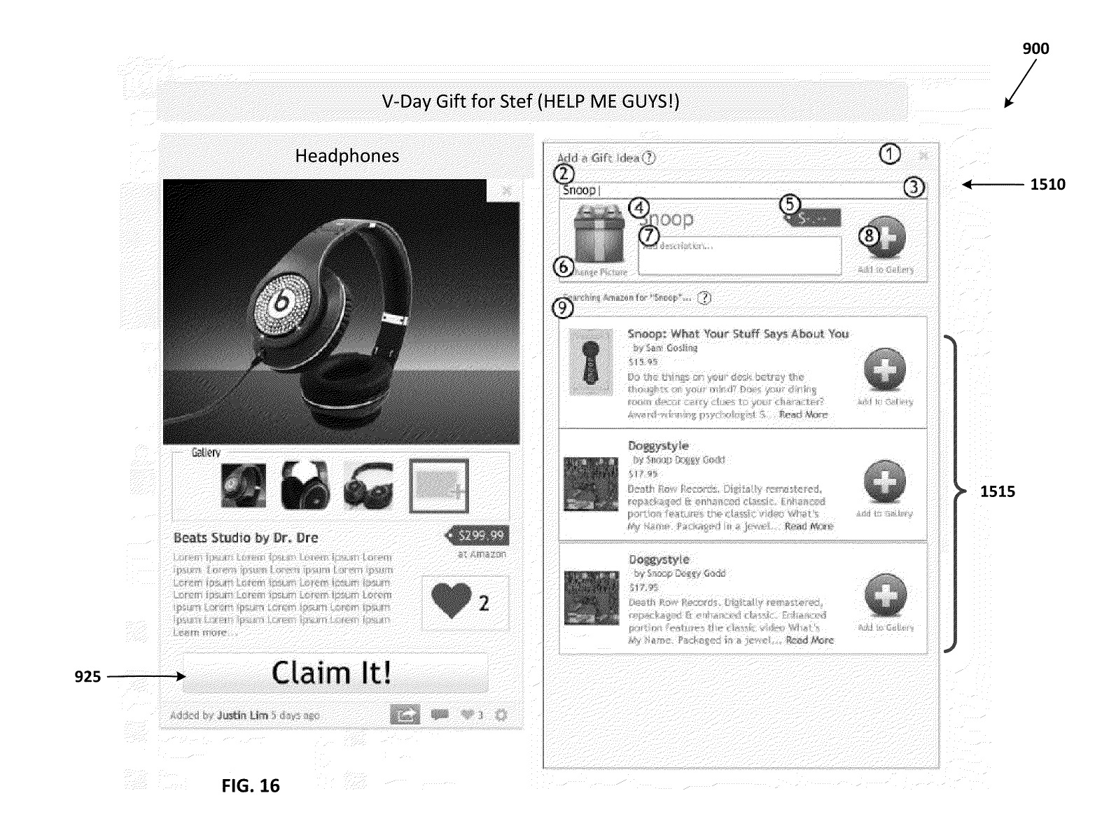

FIG. 16 illustrates an example the gift idea interface 900 where the user has begun typing in search criteria in the search criteria field 1510. The gift idea interface 900 can be configured to begin searching using keywords as the user types. The gift idea interface 900 can also be configured to wait until the user presses the enter key or a carriage return or clicks on a search button before beginning a search.

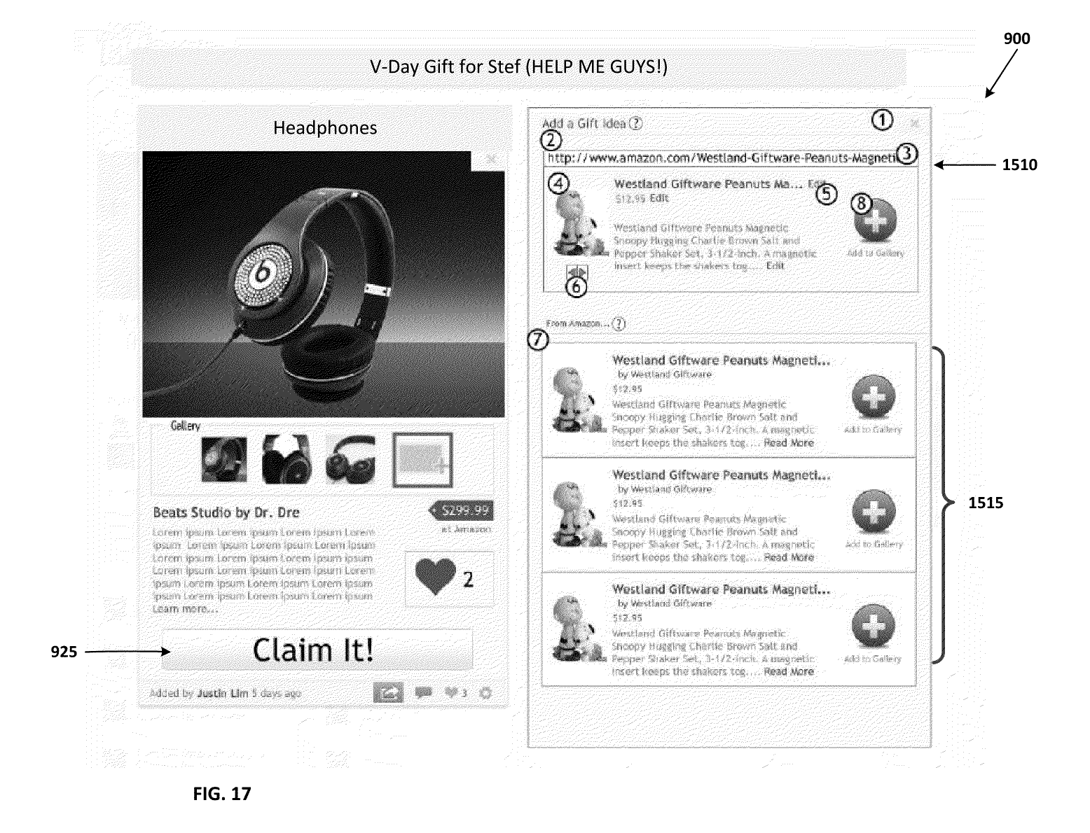

FIG. 17 illustrates an example of the gift idea interface 900 where the user has entered a URL as search criteria in the search criteria field 1510. The search results displayed in the search results section 1515 can include the item associated with the URL and the search criteria to the search module 242 can be configured to search for other online retailer offering the same or similar product for sale and list those products in the search results section 1515.

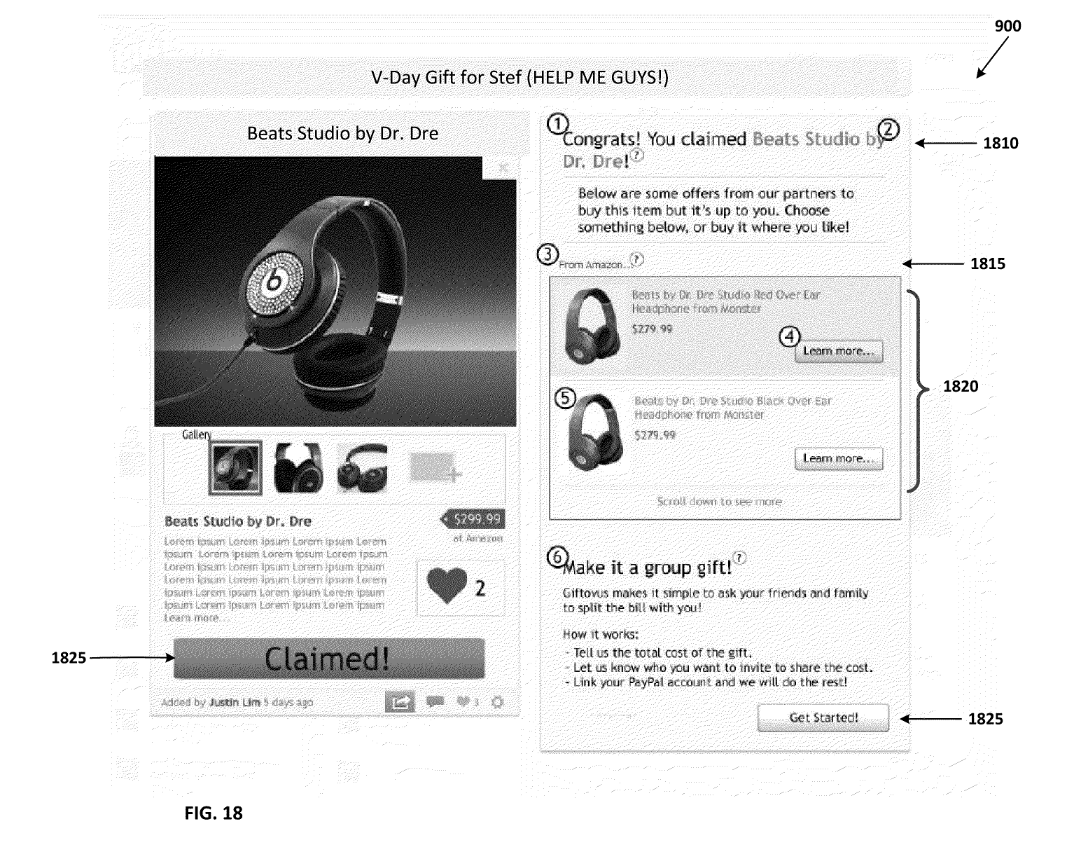

FIG. 18 illustrates an example of the gift idea interface 900 after a gift has been claimed by a user. A member of the group can claim a particular item by clicking on the claim gift idea button 925. The gift idea interface 900 can be configured to replace the gift idea button 925 with a gift idea claimed icon 1825. The gift idea interface 900 interface can be configured such that if the user clicks on the gift idea claimed icon 1825 again, the gift idea can be “unclaimed” and the gift idea button 925 will once again be displayed. Unclaiming a gift idea allows other member of the group to claim the gift idea.

Once a gift has been claimed, the gift idea interface 900 can be configured to display a claimed gift title 1810 that describes the gift that has been claimed. The gift idea interface 900 can also be configured to display product details from one or more online retailer partners that offer the claimed gift items for sale. The gift idea interface 900 can optionally display the name of an online partner 1815 before one or more products on offer 1820 available from the online retailer partner. The gift idea interface 900 can also be configured to include products on offer 1820 from other non-affiliated online retailers. The gift idea interface 900 can be configured such that products on offer 1820 from affiliated online retailers are displayed at the top of the list, while those on offer from non-affiliated online retailers may be displayed farther down in the list. Each of the products on offer 1820 can include a button, link, or other control that the user can activate to access more information about the product on offer and/or to complete a purchase of the offer. In some implementations, activating the button, link, or other control associated with a product on offer causes a the gift idea interface 900 to load a web page associated with the product on offer at the website of the online retailer, and the user can complete the purchase of the product using whatever payment system that the online retailer offers. In other implementations, the gift idea interface 900 can be configured to provide a payment interface that through which the user can execute a payment for a selected item.

The gift idea interface 900 can also include a collaborative gift item button 1825 that, when clicked, allows the user to designate the gift as a collaborative gift. Collaborative purchasing allows the user to indicate that the user would like to allow other group members to contribute toward the gift. The user interface module 222 can be configured to provide an electronic shopping cart interface that can collect payments from members and transfer the payments to the online retailer to purchase the desired goods or services from the third party retailer.

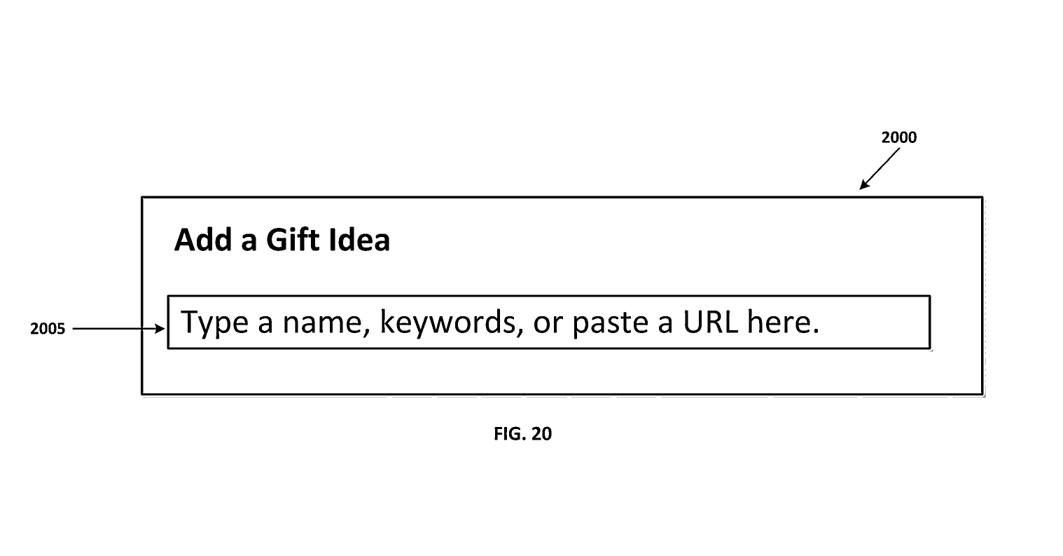

FIGS. 20, 21, and 22 illustrate an add a gift idea interface 2000 that can be used to associate a gift idea with a group. In one implementation, the add a gift idea interface 2000 can be displayed when the add gift or characteristic icon 705 included on the group interface 700 illustrated in FIG. 7 is activated. The add a gift idea interface 2000 can allow the user to manually enter gift idea information or allow the user to create a new gift idea identified in a search of products offered by online retailers that match search criteria entered by the user.

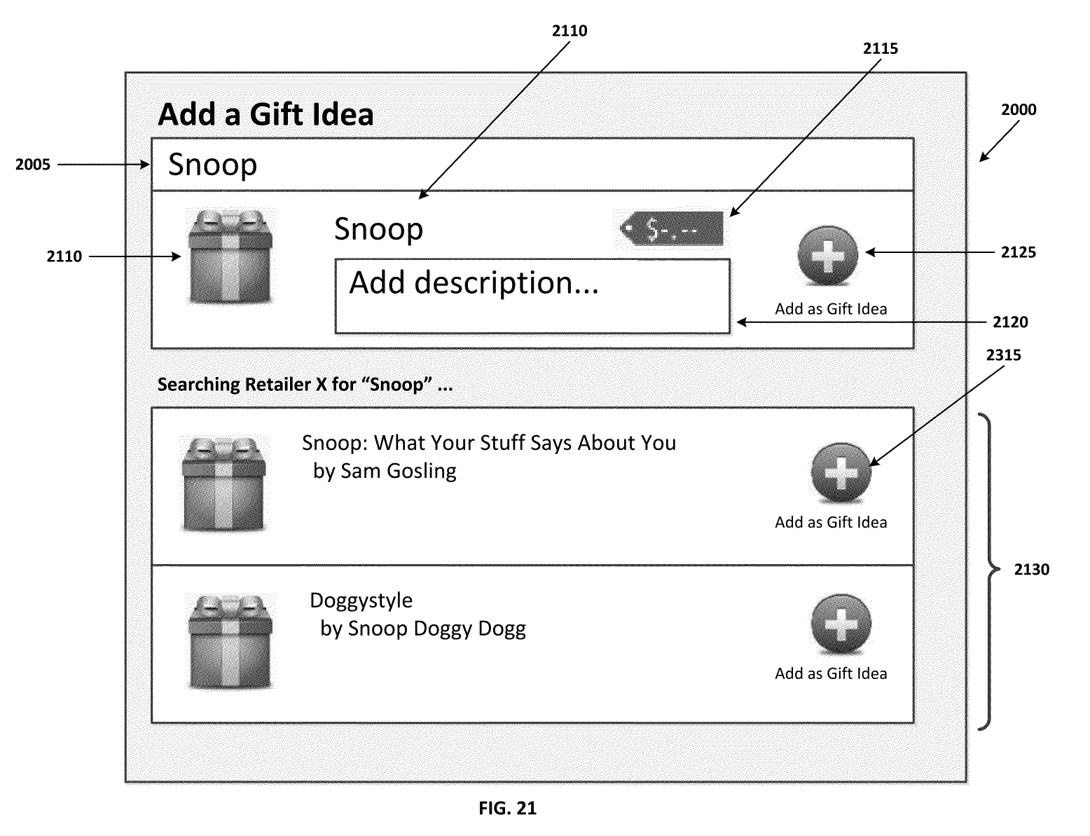

The add a gift idea interface 2000 can include a text entry field 2005 that can be used to enter a name of a gift idea, keywords associated with a gift idea, and/or a URL associated with the gift idea that can be used to identify products being offered by online retails. FIG. 21 illustrates an example of the add a gift idea interface 2000 where the user has entered text into the text entry field 2005. The add a gift idea interface 2000 can provide the text input to the user interface module 222 which can in turn provide the text input to the search module 242, which can search online retailers for products matching the text input. As the user enters text, a list of matching products 2130 can be displayed and updated as the results become available.

If the user prefers to manually enter gift idea information, the user can manually enter a price 2115 and a description 2120 for the gift idea. The user can also select a picture to be associated with the gift idea 2110. The add a gift idea interface 2000 can be configured to allow the user to select a picture to be associated with gift idea 2110 from images stored on the user's computer, from the Internet, and/or a picture associated with one of the matching products 2130. In some implementations, the add a gift idea interface 2000 can be configured to allow the user to associate multiple pictures with a gift idea. The add as gift idea button 2125 is configured to, when activated, associate the gift idea created by the user with the group. Once a gift idea has been associated with a user, the gift idea can appear in the group interface 700.

The user can also select one or more gifts ideas from the matching products 2130 to be associated with the group by clicking on or otherwise activating the add as gift idea button 2135 associated with a particular product from the list of matching products 2130.

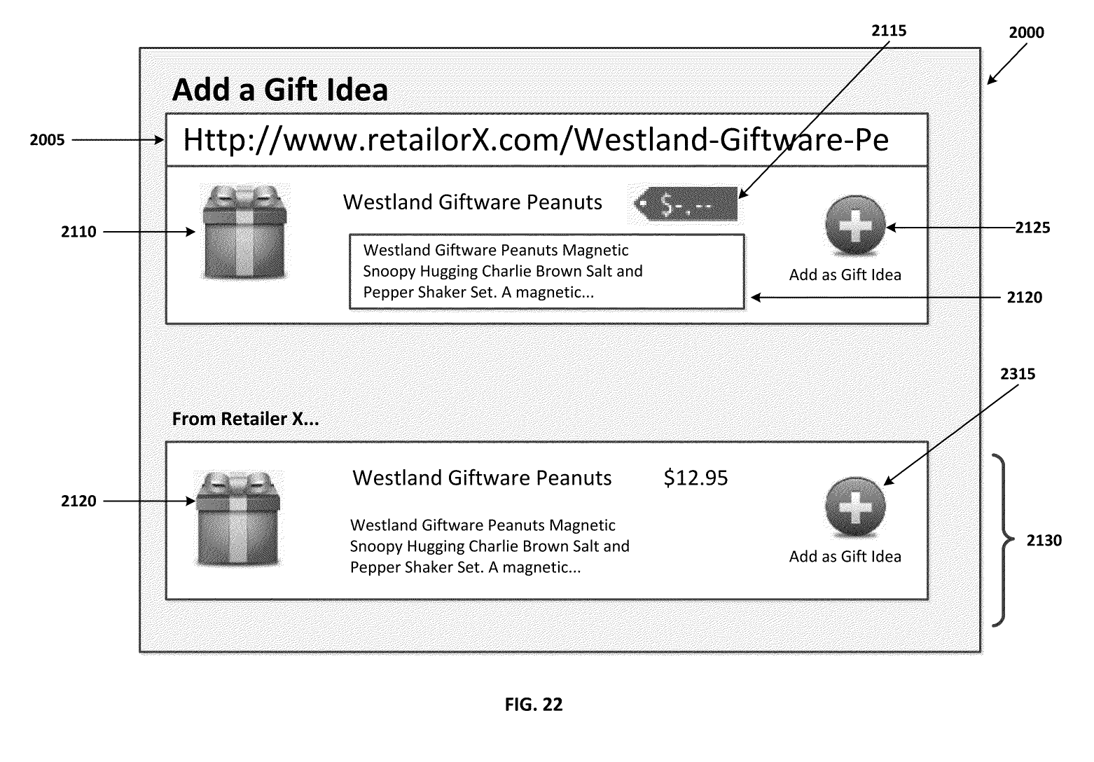

FIG. 22 illustrates an example of the add a gift idea interface 2000 where the user has entered a URL into the text entry field 2005. If the user prefers to manually enter gift idea information, the user can manually enter a price 2115 and a description 2120 for the gift idea as described with respect to the example illustrated in FIG. 21. The user can also select a picture to be associated with the gift idea 2110. The add a gift idea interface 2000 can be configured to allow the user to select a picture to be associated with gift idea 2110 from images stored on the user's computer, from the Internet, and/or a picture associated with one of the matching products 2130. A list of matching products associated with the URL entered can be displayed in the list of matching products 2130. The add gift button 2125 and the add gift button 2135 function similarly as the one illustrated in FIG. 21.

The number of matching products 2130 illustrated in FIGS. 21 and 22 are merely illustrative and the actual number of matching products 2130 may vary based on the search criteria entered and is not limited to the examples illustrated in FIGS. 21 and 22.

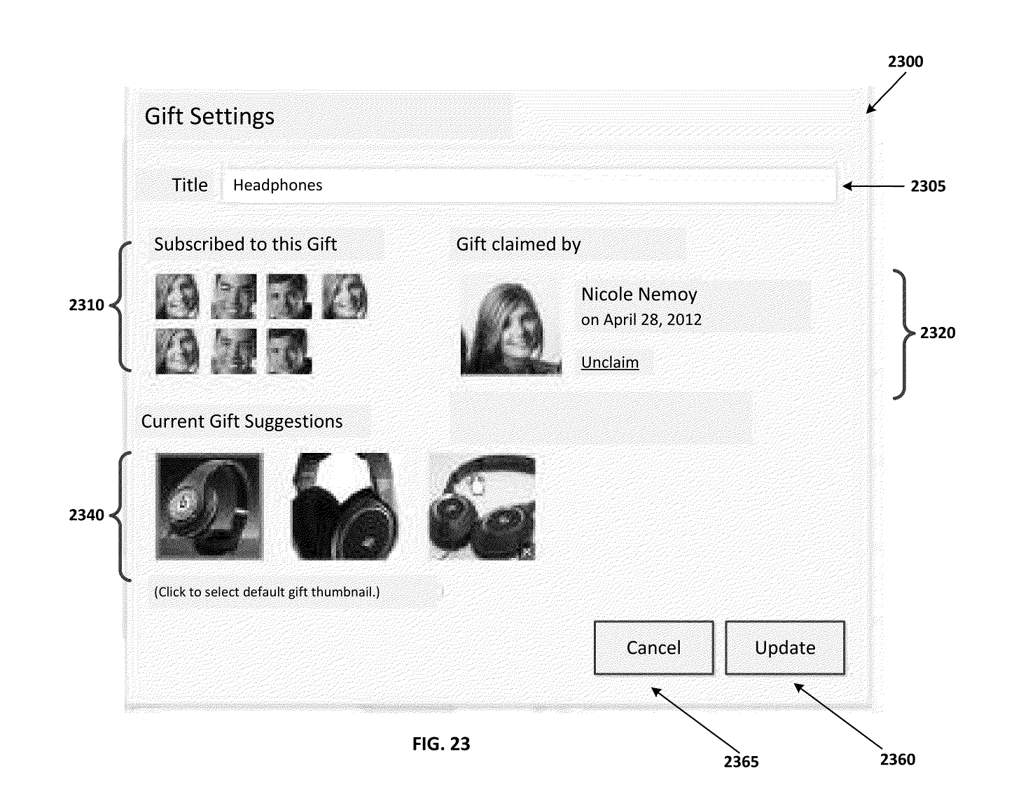

FIG. 23 illustrates a gift idea settings interface 2300 that can be used to associate a gift idea with a group. The gift idea settings interface 2300 can be used to view and/or update information associated with the gift associated with a group. The gift idea settings interface 2300 can include a gift title field 2305 can be configured to display the title of the gift (if one has already been provided) and to allow a user to edit or enter a new title to be associated with the gift idea. The members subscribed to this gift gallery 2310 provides a listing of the users who are subscribed to receive updates regarding this gift. Subscribed members can be provided with updates when changes are made to the gift idea. For example, members of subscribed to the gift can be notified if someone claims the gift idea, someone purchases the gift, or if a collaborative purchase has received enough funds to purchase the gift. The gift claimed by user information 2320 can display information about a user that has claimed the gift idea (if any) and can include a control that allows the user who created the gift idea, the user who claimed the gift, or an administrator to “unclaim” the gift. Unclaiming the gift causes the gift collaboration system to reset the gift to an unclaimed state, which allows other members associated with the group to claim the gift.

The current gift suggestions 2340 can provide a gallery of gift items that have been associated with a particular gift idea. In the example illustrated in FIG. 23, the current gift suggestions 2340 include three pairs of headphones that have been suggested by members of the group with which the gift idea is associated. Members of the group can suggest gift ideas using the various interfaces described above. The gift idea settings interface 2300 can also be configured to allow the creator of a gift idea, the member who added a gift item to the gift idea, or an administrator can also delete a gift item. The update button 2360 can be configured to allow the user to save any changes to that were made to the gift settings. The update button 2360 can also be configured to close the gift idea settings interface 2300 after the gift settings have been updated. The cancel button 2365 can be configured to allow the user to cancel any changes that were made to the gift settings, to close the gift idea settings interface 2300, and to return to the previous interface.

The gift settings interface 2300 can be configured to allow the only allow a user who created the gift or an administrator from the group with which the gift is associated to edit or delete a gift.

One aspect of the gift collaboration system is that user can create wish lists of items that they would like to receive. A user can add items to a wish list that can be made visible to members of groups where the user is the receiver associated with that group. The items on the wish list can appear in the group interface 700 illustrated in FIG. 7, providing information to group members regarding the types of things that the user likes and would like to receive.

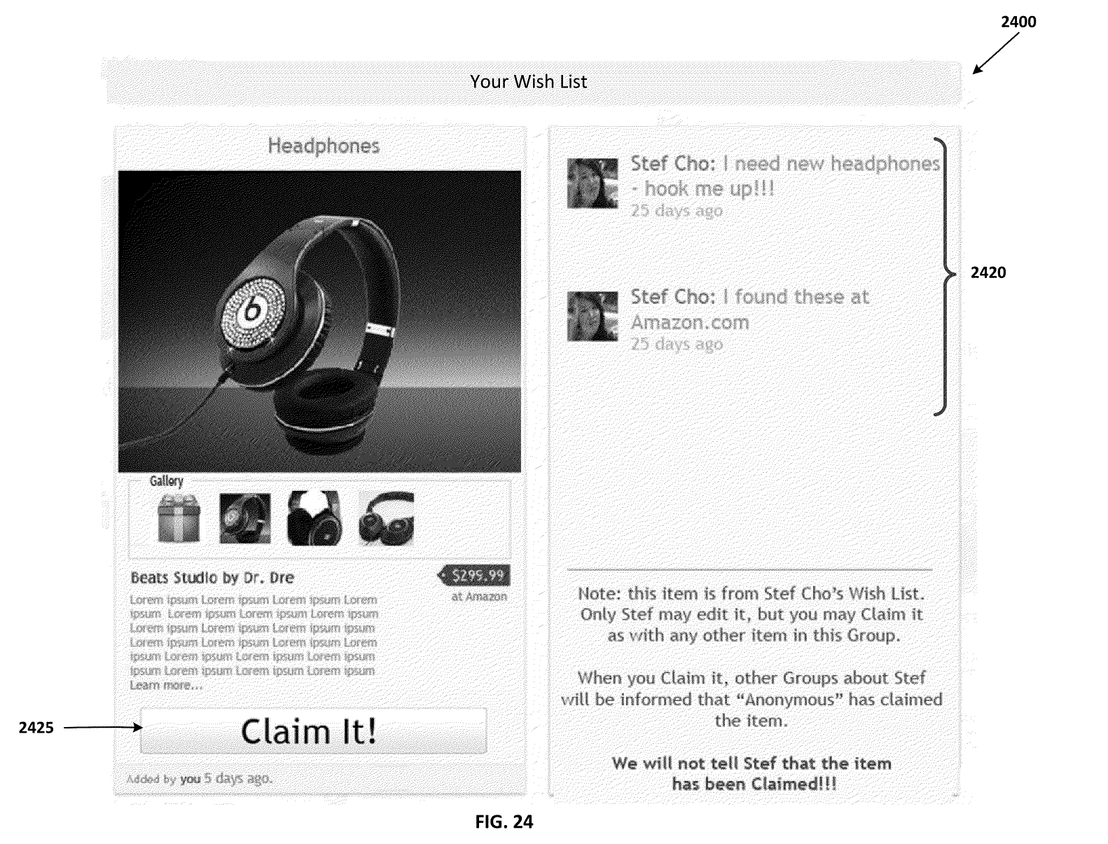

FIG. 24 illustrates a wish list item interface 2400 that is similar to the gift idea interface 900. The wish list item interface 2400 can include a claim item button 2425 that operates similarly to the claim item button 925 illustrated in FIG. 9 and allows a member of the group to claim a gift item on the user's wish list. The wish list item interface 2400 can also include a purchase button (not shown) that operates similarly to the purchase button 1925 illustrated in FIG. 19 and operates to allow a member of the group to claim and purchase a particular gift. The wish list item interface 2400 can also include receiver comments 2420 where the receiver can post information comments about the wish list item that can be viewed by members of the group if the receiver has configured the wish list to be visible to group members.

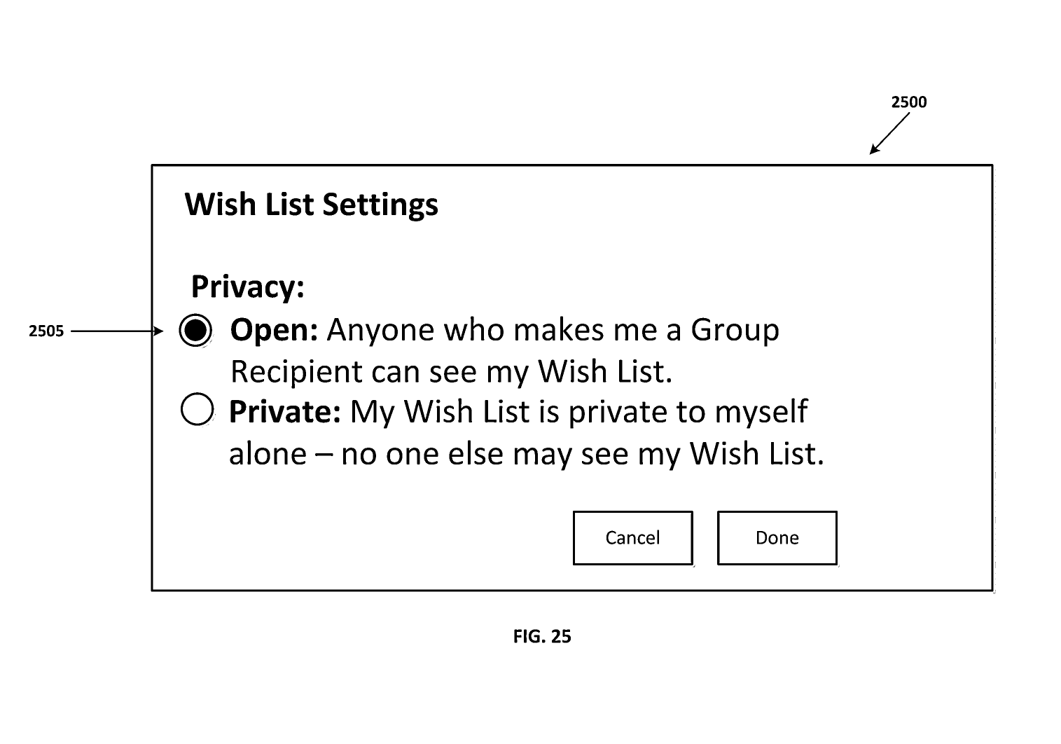

FIG. 25 is an example of a wish list settings interface that can be provided by the gift collaboration system to allow a receiver to configure the privacy settings of his or her wish list. The wish list interface includes a privacy level setting 2505 that allows the user to set the privacy level setting associated with his or her wish list. In the example illustrated in FIG. 25, there are two privacy level settings. The first option is “open” where anyone in a group that makes the receiver a recipient of a gift can view the wish list. The second option is “private” where only the user that created the wish list can view the contents of the wish list. The privacy levels illustrated in this example are merely one example of levels of privacy setting levels that may be used and other implementations might include additional privacy level settings and/or other privacy levels settings.

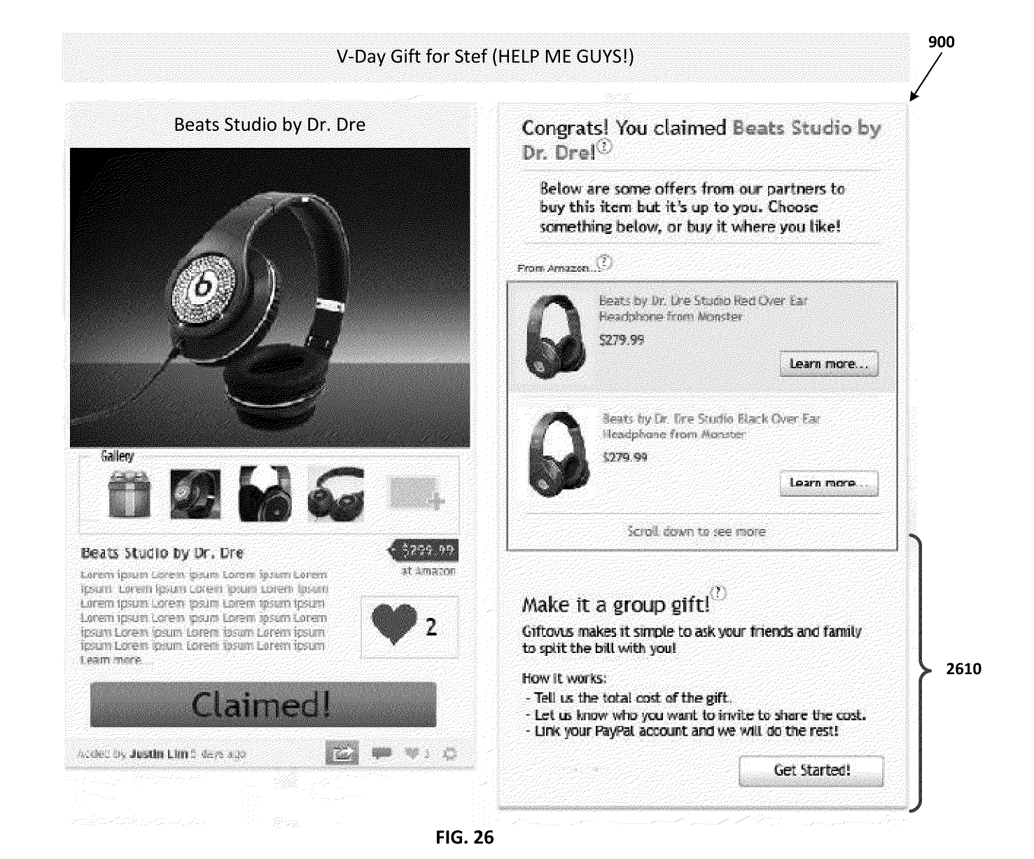

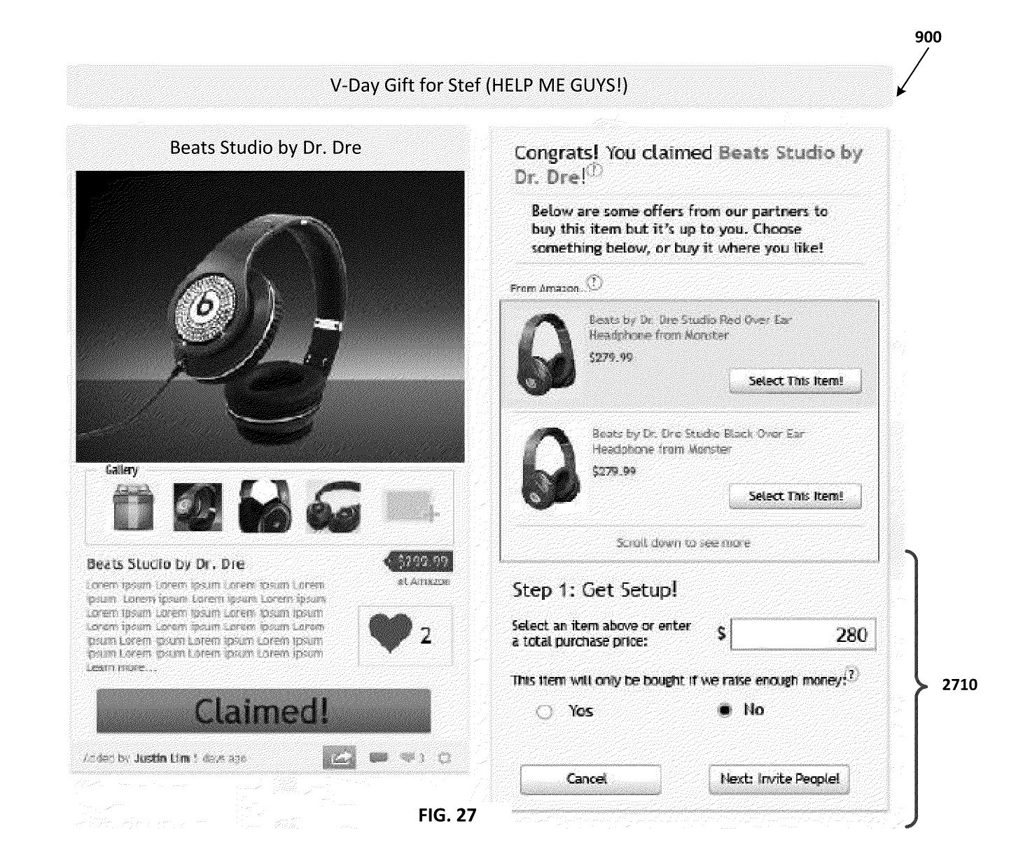

FIGS. 26-36 illustrate examples of the gift idea interface 900 where the user has elected to claim a gift and designate the gift as a collaborative purchase where contributions toward the gift can be solicited from other members of the group. FIG. 26 illustrates an example of the gift idea interface 900 where a gift item has been claimed. The gift idea interface 900 includes a collaborative purchase section 2610 that allows the user to designate the claimed gift item as a collaborative purchase and to configure parameters of the purchase. FIG. 27 illustrates an example of the gift idea interface 900 where the collaborative purchase section 2610 has been replaced by a collaborative purchase parameters section 2710 that includes fields for capturing information about the collaborative purchase. In the example illustrated in FIG. 27, the collaborative purchase parameters 2710 include a total purchase price and an option to only purchase the gift item if enough money is raised. The total purchase price can be treated as a threshold amount and compared to the contributions collected from group members to determine whether to purchase the gift item.

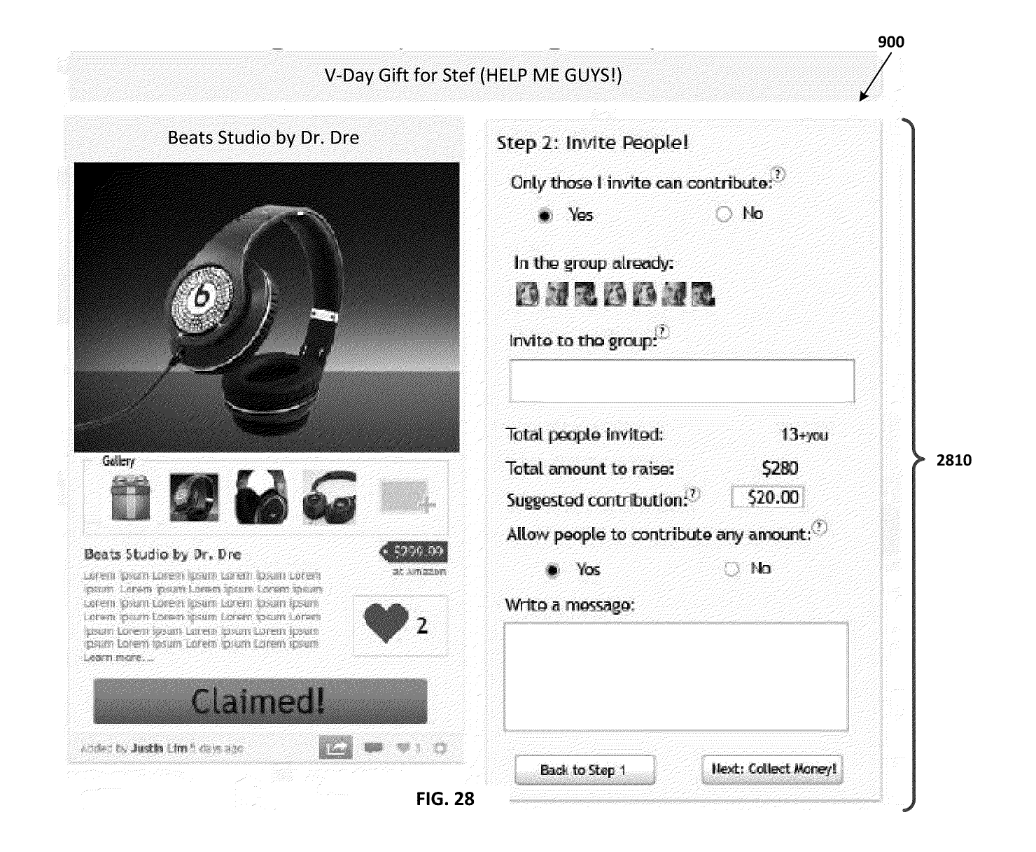

FIG. 28 is an example of the gift idea interface 900 that includes additional collaborative purchase parameters 2810. For example, the additional collaborative purchase parameters 2810 illustrated in FIG. 28 allows the user to select which members of the group are invited to participate in the collaborative gift and/or select all members of the group. The additional collaborative purchase parameters 2810 also allow the user to specify a suggested contribution amount and can allow the user to set provide a message to display to those invited to contribute to the collaborative purchase. The collaborative purchase parameters 2810 can also allow the user to specify a set contribution amount to be made by contributors and/or a maximum or minimum contribution amount.

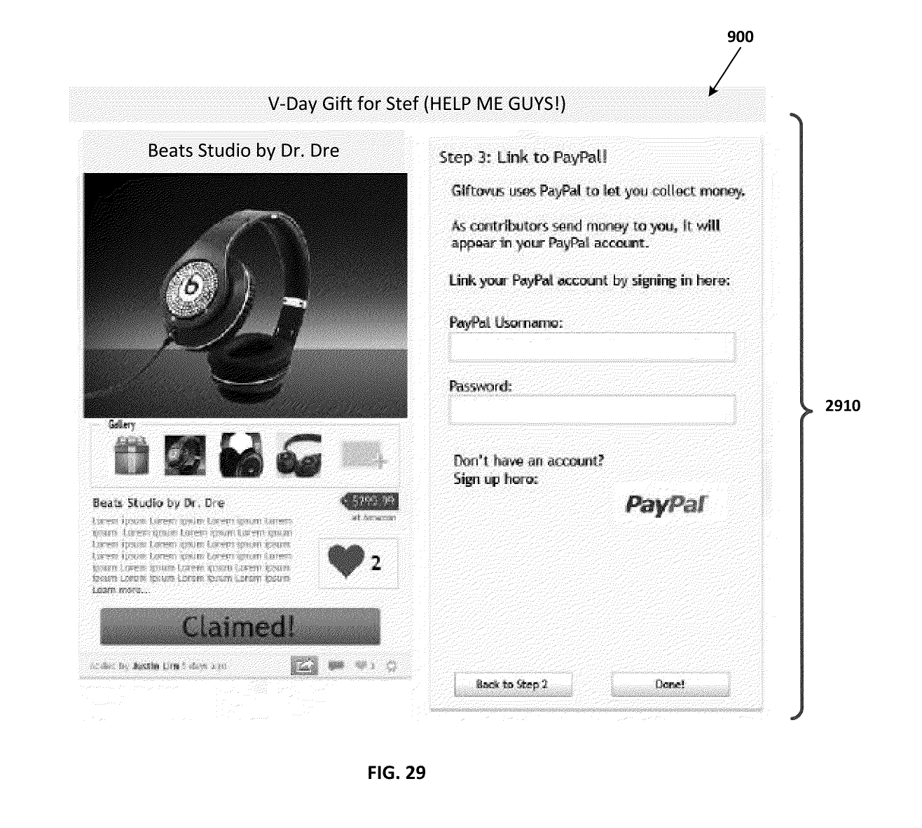

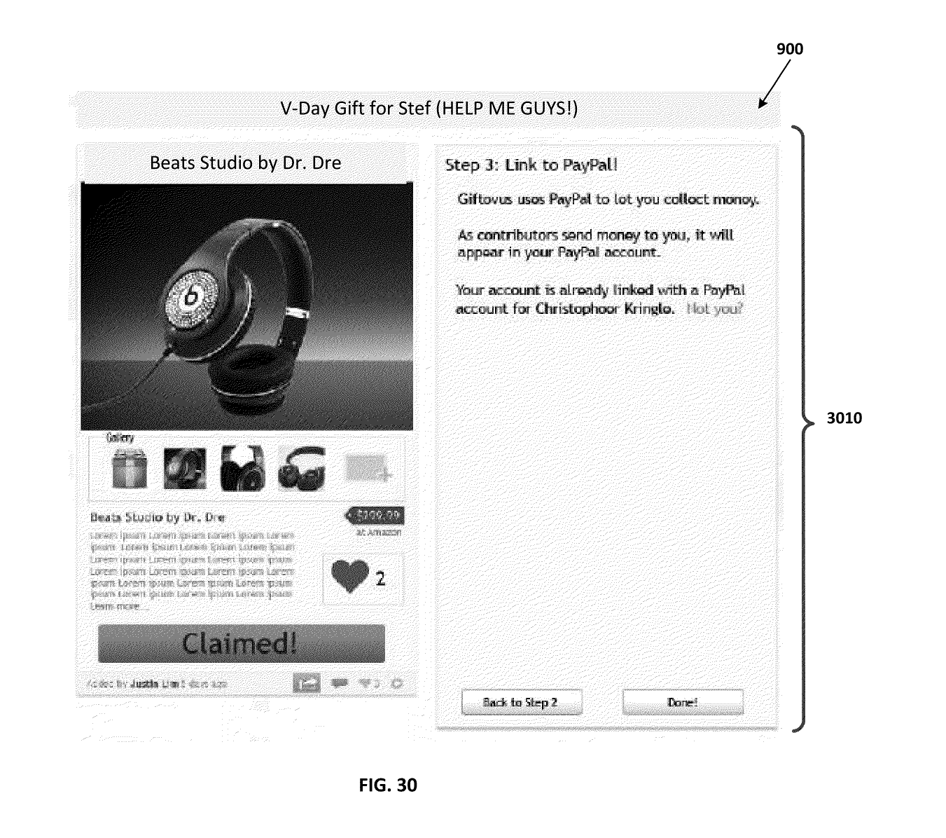

Once the collaborative purchase parameters have been set, the user can set up a purchase account that can be used to deposit funds contributed by members of the group. FIG. 29 illustrates an example of the gift idea interface 900 where an account information section 2910 is included. The account information section 2910 allows the user to enter account information where contributions toward the gift are to be deposited. The purchasing module 230 of the gift collaboration system can be configured to allow the user to user various types of accounts, such as a third party payments system (e.g. Paypal), a deposit account at a bank, a credit card, or other types of account. In the example illustrated in FIG. 29, the account information section 2910 is asking the user to enter details of a Paypal account, but the interface could be modified to request information for other types of account or to allow the user to select an account type that the user would prefer to use for deposits. FIG. 30 illustrate an example of a confirmation 3010 that can be displayed to the user once an account has been successfully linked to the collaborative purchase of the gift.

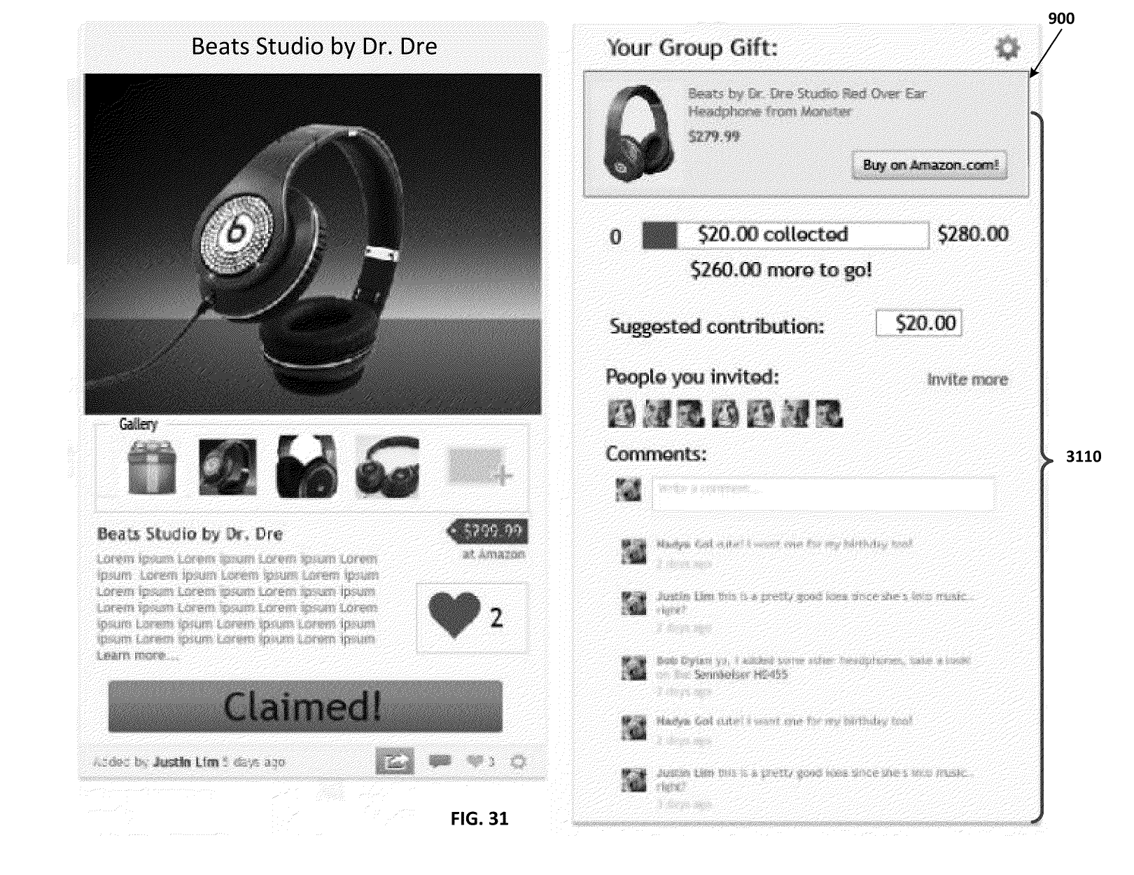

FIG. 31 illustrates an example of the gift idea interface 900 that has been updated to display collaborative purchase details 3110. The view illustrated in FIG. 31 is a view that can be displayed to the user that claimed the gift and set up the collaborative purchase. The collaborative purchase details 3110 include the current contributions toward the gift and can allow the user to modify parameters of the collaborative purchase, such as the suggested contribution and the invitees. Other implementations may also allow the user to modify other parameters of the collaborative purchase.

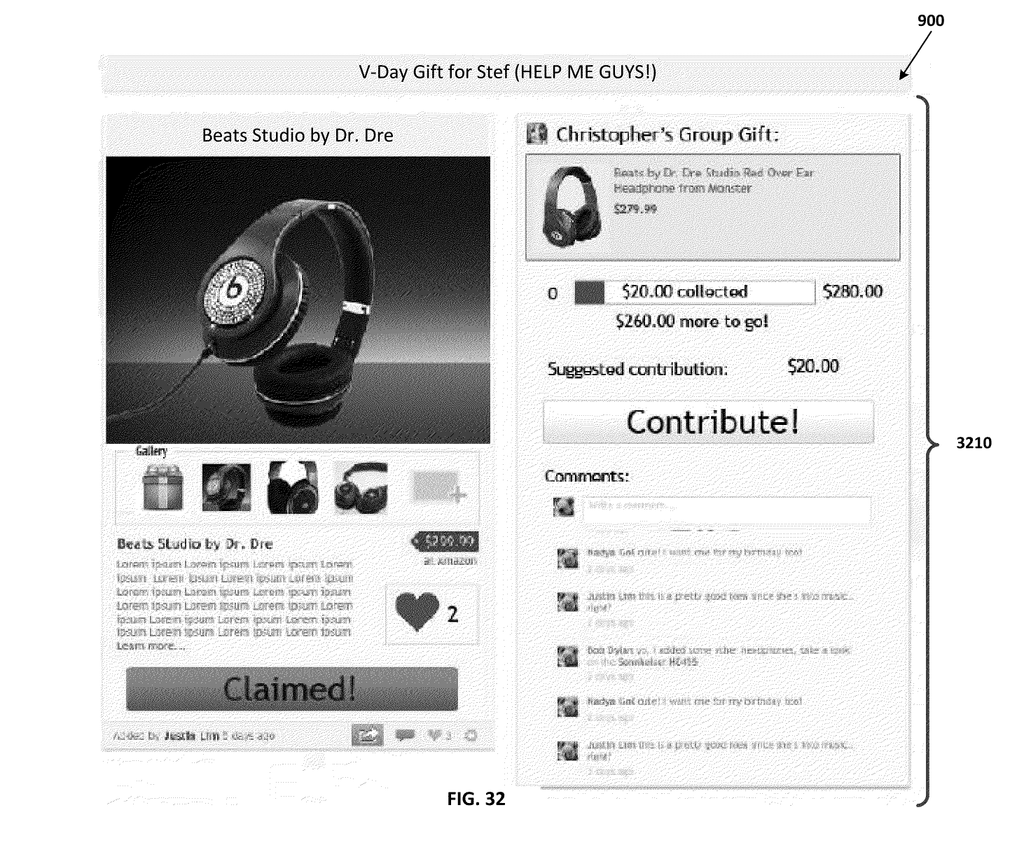

FIG. 32 illustrates an example of the gift idea interface 900 that displays collaborative purchase details 3210. The view illustrated in FIG. 32 is a view that can be displayed to other members of the group who are not the user that claimed the gift and set up the collaborative purchase. The collaborative purchase details 3210 can include read-only details of the collaborative purchase and can include a contribute button that allows those invited to contribute to the collaborative purchase to make a contribution toward the purchase of the gift.

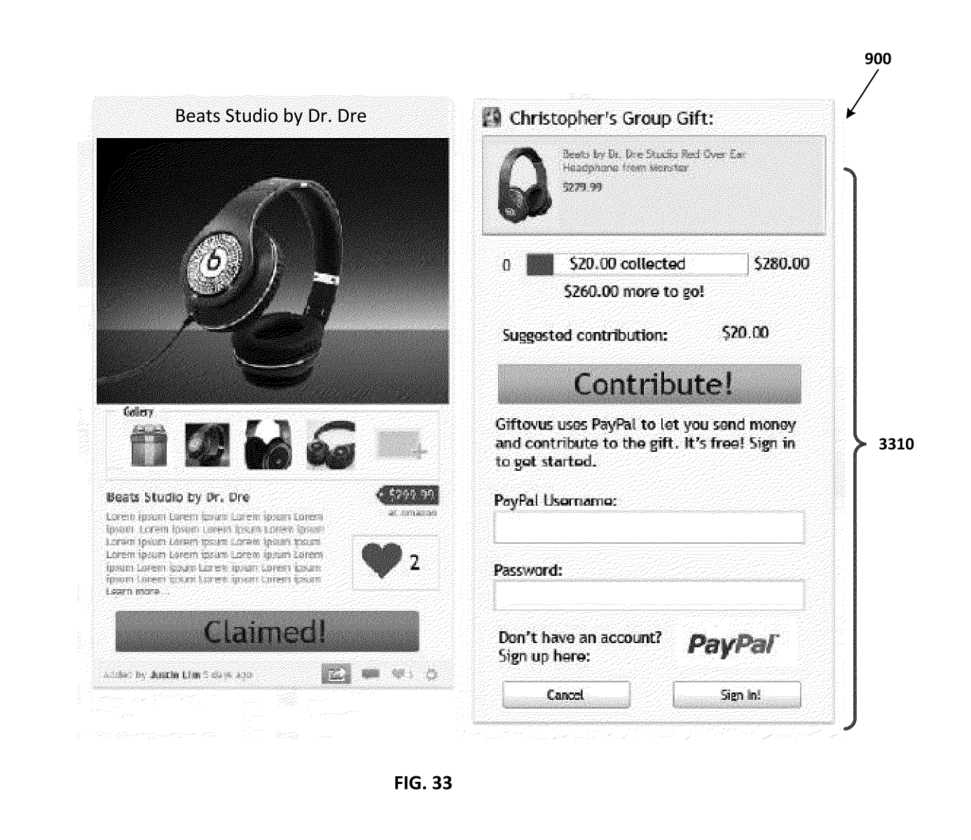

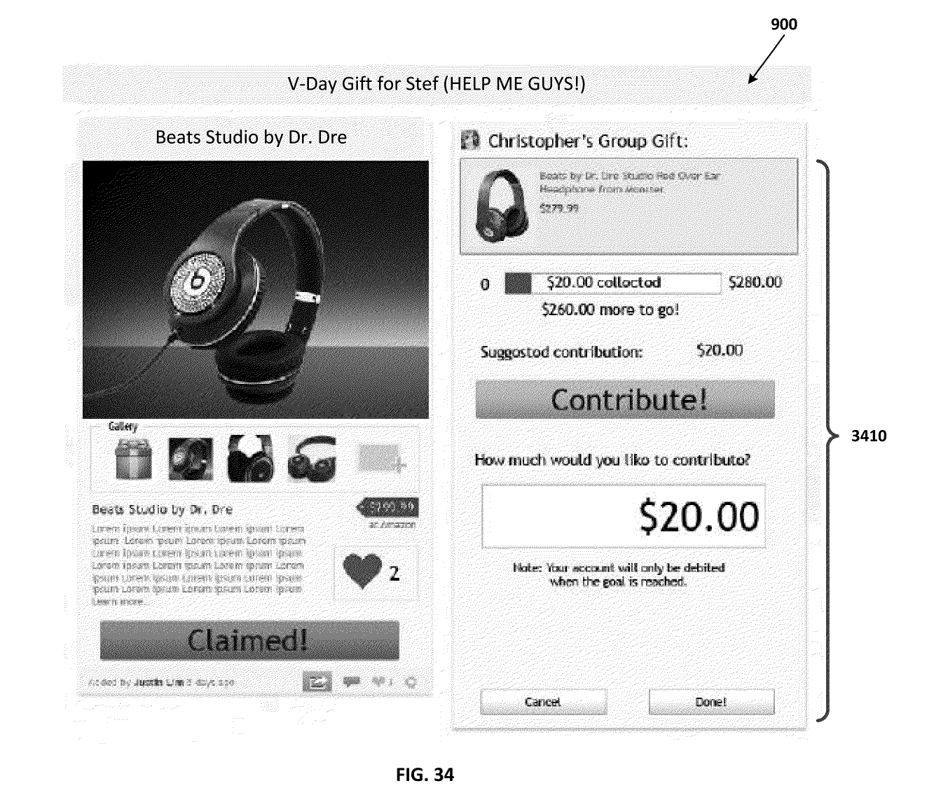

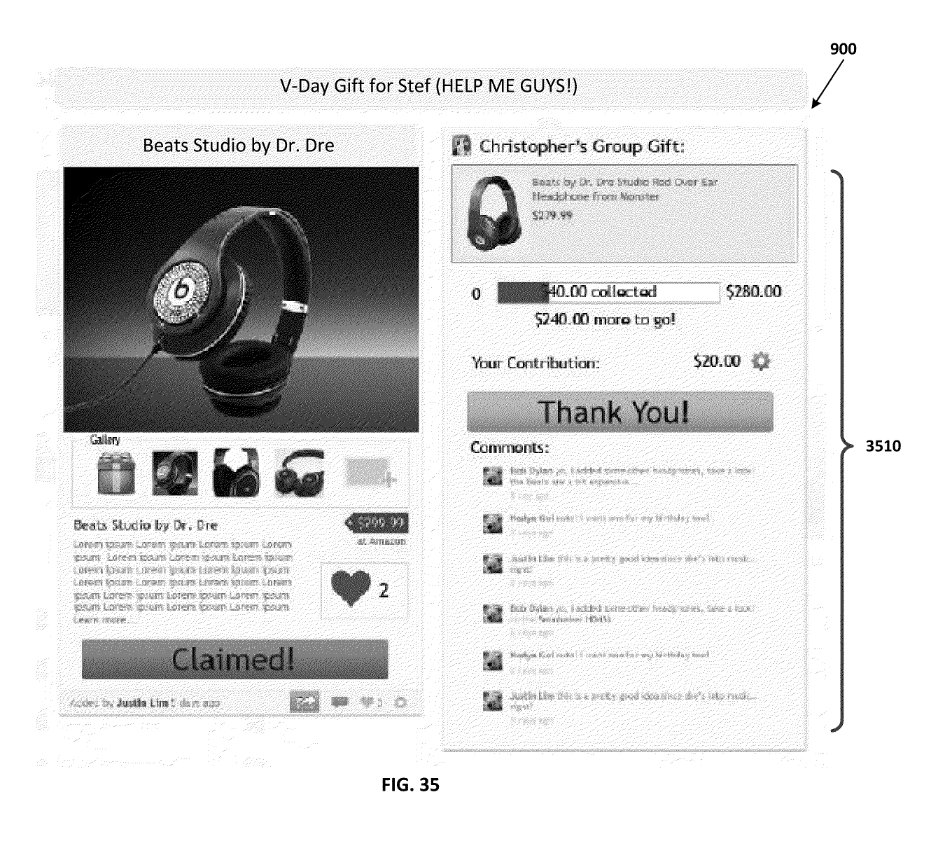

FIG. 33 illustrates an example of the gift idea interface 900 where a user has clicked the contribute button illustrated in FIG. 32 and the collaborative purchase details 3310 have been updated to allow the user to enter payment account information. The example of FIG. 32 illustrates a Paypal account being used as the payment account, but as described above various types of payment accounts can be used and the collaborative purchase details 3310 can be configured to display an appropriate set of account information fields depending on the type of account selected. FIG. 34 illustrates a view of the gift idea interface 900 after the user has entered the payment account information and the collaborative purchase details 3410 are displayed. The collaborative purchase details allow the user to enter a contribution amount and confirm the contribution. FIG. 35 illustrates a view of the gift idea interface 900 where the collaborative purchase details 3510 display a confirmation of the contribution made by the user.

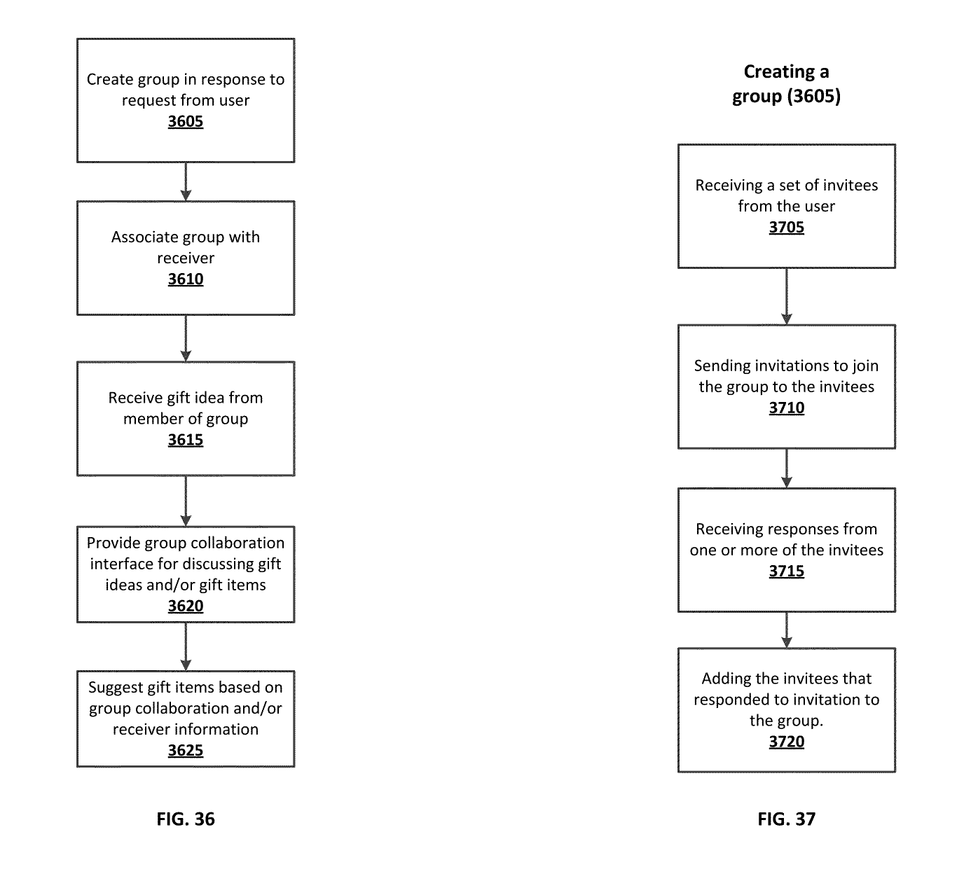

FIG. 36 is a flow diagram of a method for facilitating collaboration on gift ideas for a recipient in the gift collaboration system. A group can be associated with a particular receiver who is the intended recipient of gifts associated with the group. Members of the group can collaborate to develop gift ideas and may claim gifts that they intend to purchase for the receiver.

The gift collaboration system can create a new group in response to a request from a user (stage 3605). For example, a user can use the create group interface 300 described above to create a new group. The request from the user can include various information about the group, such as the who is the intended receiver associated with the group, who should be invited to join the group, a name for the group, a description of the group, and an image that can be displayed in association with the group, and/or other information.

The gift collaboration system can be configured to associate the group with existing receiver (stage 3610). The receiver module 252 of the gift collaboration system can be configured to search for an existing receiver that is associated with one or more groups and/or wish lists in the system. The system can be configured to suggest to the user creating the group that one or more potentially matching existing receivers have been found and to present a list of the potential matches to the user creating the group. The user creating the group can select one of the existing users or indicate that the group is not associated with any of the potential matches identified by the gift collaboration system, and a new receiver can be created. If the user indicates that the group is being created for an existing receiver, the gift collaboration system can be configured to associate the newly created group with the existing receiver. The existing receivers can be identified using various techniques. For example, an existing receiver can be matched to the name, email address, or other identifying information provided by the user creating the new group. The receiver can be identified using information in a contact list and/or the social network connections associated with the user creating the group. The information provided by the user creating the group and the information collected from the user's contacts and/or social network connections can then be used by the receiver module 252 to search for potential matches in the system. The gift collaboration system can attempt to match the information provided by the user and that determined by the system with existing receivers that are already in the system. The receiver module 252 of the gift collaboration system can attempt to match with any user registered with the system whether that user is a receiver or merely a member of one or more group.

Once a group has been created, the gift collaboration system can receive gift idea information from a member of the group (stage 3615). For example, a user associated with the group can create a new gift idea associated with the group using the gift idea interface 900 described above. The gift idea information can include a name for the gift idea, a description associated with the gift idea, and one or more suggested gift items that to be associated with the gift idea. The suggested gift items can be items that the user creating the gift idea believes may be good candidates for gifts for the receiver associated with the group and that the user would like to discuss with other members of the group. Other members of the group can also suggest gift ideas once the group has been created. The gift collaboration system can also be configured to provide a group collaboration interface for discussing the gift idea once the gift has been created (stage 3620). For example, the various interfaces discussed above, including the group interface 700 and the gift idea interface 900 provide a group collaboration interface where group members can collaborate on gift ideas for a recipient. The gift idea interface 900 can be used by members of the group to collaborate on the gift idea. For example, members of the group can post comments associated with gift ideas that can be viewed and responded to by other members of the group. The gift idea interface 900 can also allow members of the group to associate additional gift items with the gift idea. The gift idea interface 900 can also be configured to allow members of the group to invite others to join the group. The group idea interface 900 can be configured to prevent the receiver from being invited from joining the group and/or can also be configured to prevent the receiver from accessing the gift idea information, such as the suggested products, the comments posted by the users, and/or viewing who is a member of the group.

One or more gift items can also be suggested for the recipient based on the group collaboration information and/or recipient information (stage 3625). The recommendation module 240 of the gift collaboration system can be configured to suggest gift items for the recipient based on the group collaboration information and/or the recipient information determined in stage 3615. For example, an existing receiver can have one or more active groups associated with that receiver or may have one or more groups that were created to collaborate on gift ideas for past events. Each of these groups may have one or more gift ideas and/or gift items associated with that group. The information associated with both the currently active groups and the past groups can be archived by the system and used to build a profile for the recipient that can be used to identify what types of gifts items that the receiver may be interested in receiving. The receiver can also have one or more wish lists associated with the receiver. For example, a receiver could have a wish list for her birthday, a wish list for Valentine's Day, and a wish list for her wedding in the system. Some of the list may be active while others may be associated with past events and are no longer active. The gift collaboration system can archive the user's wish lists and use the archived data to further build the profile associated with the recipient. The advertising module 236 of the gift collaboration system can also be configured to select one or more targeted advertisements to display to the user based on the group collaboration information and/or the recipient information determined in stage 3615. The targeted advertisements can be selected from one or more affiliated retailers that offer products that may be of interest to the receiver based on the information collected for the receiver, such as past gifts and wish list information) and the discussions between members of the group. The user interface module 222 can be configured to provide an interface that allows the user to select one or more of the advertised items to be associated with the group as gift items. The user interface module 222 can also be configured to interface with the purchasing module 230 to allow the user to claim and/or purchase the selected gift items.

FIG. 37 is a flow diagram of a method for adding members to a group in the gift collaboration system. The method includes receiving at the gift collaboration system a set of invitees from a member of the group (stage 3705). The member of the group can be the user that created the group or can be another member of the group. In some implementations, the user can invite users to join the group at the time that a group is created by using the create group interface 300. A user can also invite users to join an existing group via the group settings interface 500. The user who created the group can also opt to limit the invitation of additional members to the group to that user or to administrator users associated with the group at the time that the group is created using the group interface 300. The group settings interface 500 can also be configured to include controls that allow the user that created the group or a group administrator to change the group settings that indicate whether other users in the group may invite others to join the group. In some implementations, the gift collaboration system can be configured to suggest potential invitees to the user. For example, the gift collaboration system can be configured to suggest invitees that are in the contact list or are social network contacts of the receiver associated with the group and/or with members of the group.

The gift collaboration system can be configured to send invitations to the invitees (stage 3710). The gift collaboration system can include an invitation processing module 224 can configured to receive requests to invite users to join a group. As described above, the invitation processing module 224 can be configured to send electronic invitations to the invitees using various techniques, such as private messages via social networking services, email, text messages. The invitations can include a web address for a new account creation page that allows the invitee to create an account with the gift collaboration system or to log into an existing account and link that account to the group. The invitations can also include a hyperlink that the user can click to be automatically redirected to a landing page on the gift recommendation service that allows users to create a new account. The invitations can also include a unique code that is associated with the invitation that will identify the invitee to the gift recommendation service.

Responses from one or more of the invitees can then be received (stage 3715) and invitees that responded affirmatively to the invitation to join the group can be added to the group (stage 3720). The invitation processing module 224 can also be configured to process responses received from invitees based on the various techniques described above. In some implementations, a “shell” or incomplete account can be created for a user that responds affirmatively to the invitation if that user does not already have a user account on the gift collaboration system and the invitee can be prompted to complete the account registration when the invitee visits the gift collaboration system or through reminders sent to the invitee. If an invitation was sent to a known user of the gift collaboration system, the user can be added to the group when an affirmative response is received from the user. If an invitee has a user account but was not identified by the gift collaboration system at the time that the invitation was generated, the invitation can include an option that allows the user to provide authentication credentials to the gift collaboration system so that the invitation is associated with the user's account and the user is added to the group.

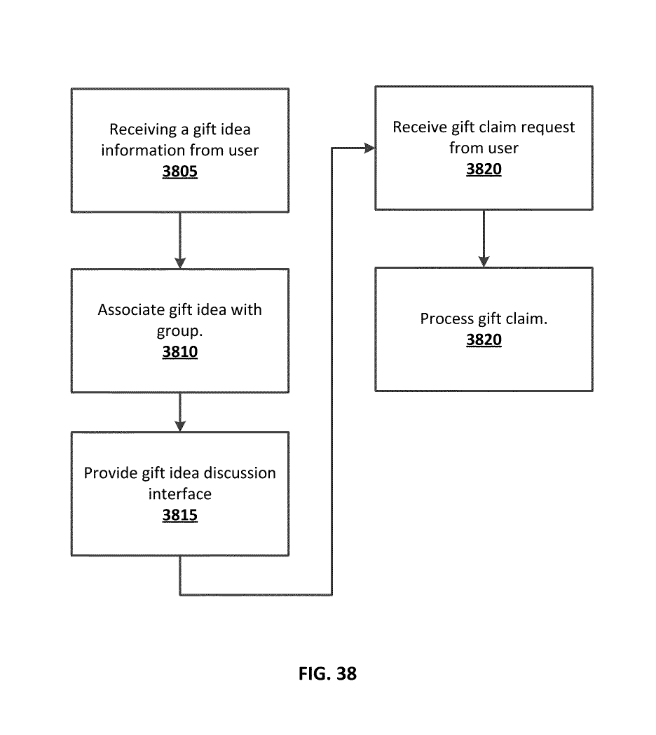

FIG. 38 is a flow diagram of a method for creating a new gift idea in the gift collaboration system. The gift collaboration system can receive gift idea information from user (stage 3805). For example, the gift collaboration system can be configured to receive gift idea information from a user via the gift idea interface 900 illustrated in FIG. 9. The gift idea information can include a name for the gift idea, a description associated with the gift idea, and one or more suggested gift items that to be associated with the gift idea. The suggested gift items can be items that the user creating the gift idea believes may be good candidates for gifts for the receiver associated with the group and that the user would like to discuss with other members of the group. Other members of the group can also suggest gift ideas once the group has been created.

The gift collaboration system can then associate the gift idea with the group (stage 3810) and to provide a gift discussion interface (stage 3815). When a request to create a new gift idea is received, the gift collaboration system can create a new record in the data store 250 representing the new gift idea and associate the record with the group. Once a gift idea has been associated with a group, members of the group can see that gift idea, discuss the gift idea, collaborate on gift items associated with the gift idea, and/or claim gift ideas via the gift idea interface 900. The gift ideas associated with a group can be accessed via the group interface 700 illustrated in FIG. 7.

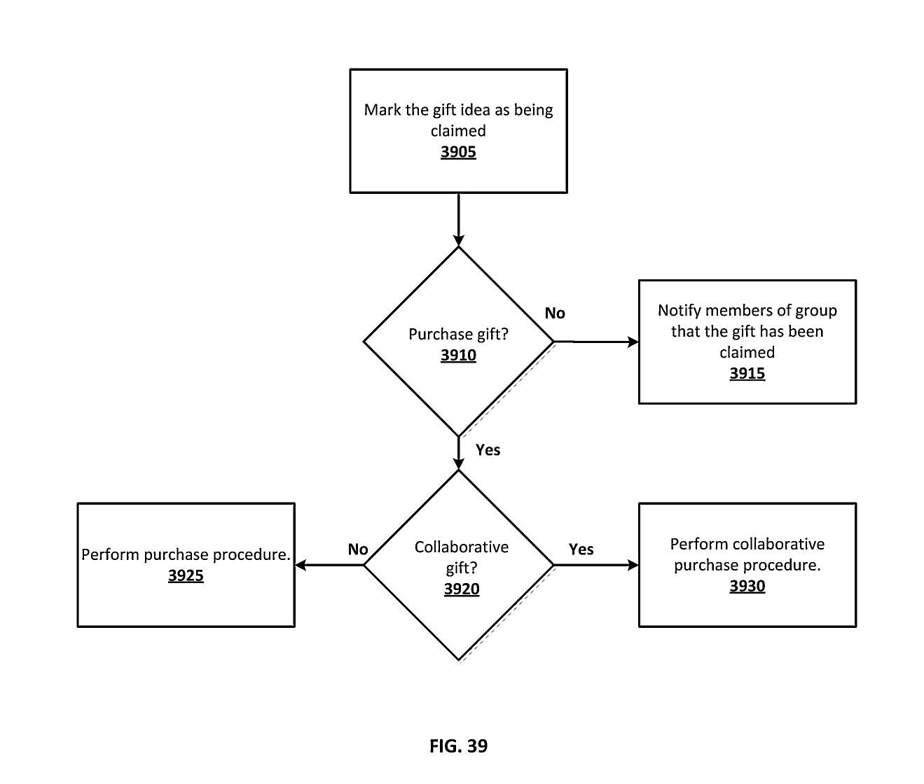

The gift collaboration system can also be configured to receive a gift claim request from a member of the group (stage 3820). In one implementation, the gift idea interface 900 can include a claim gift button 925 that a member of the group can use to claim a particular gift. The gift collaboration system can then be configured to process the claim (stage 3825). As described above, claiming a gift indicates that the user intends to purchase that gift for the receiver and the gift is marked as claimed so that other user may not claim that gift. In some implementations, the gift collaboration system may be configured to require that the user confirming the gift confirm that the gift has been purchased within a specific time period otherwise the gift collaboration system can be configured to unclaim the gift and make the gift available to other users to claim. A method for processing a gift claim is illustrated in FIG. 39.

FIG. 39 is a flow diagram of a method for processing a request to claim a gift in the gift collaboration system. The method illustrated in FIG. 39 can be used to implement the step 3825 in the method illustrated in FIG. 38. The gift collaboration system can be configured to mark the gift as being claimed (stage 3905). Marking the gift as being claimed prevents other users from attempting to claim the same gift for the receiver. For example, the claim gift button 925 included in the gift idea interface 900 can be disabled in response to a user claiming a gift. The gift idea interface 900 can also be configured to display which user has claimed a gift and whether the gift has been claimed as a collaborative gift. The gift collaboration system can then make a determination whether the user has requested to purchase the gift (stage 3910). If the gift collaboration system determines that the user has claimed the gift, but has not requested that the user has initiated an online purchase, the gift collaboration system can notify members of the group that have subscribed for updates for the gift idea that the gift has been claimed (stage 3915). A user can elect to claim a gift item and to purchase the gift item offline or from an online retailer not affiliated with the gift collaboration system.

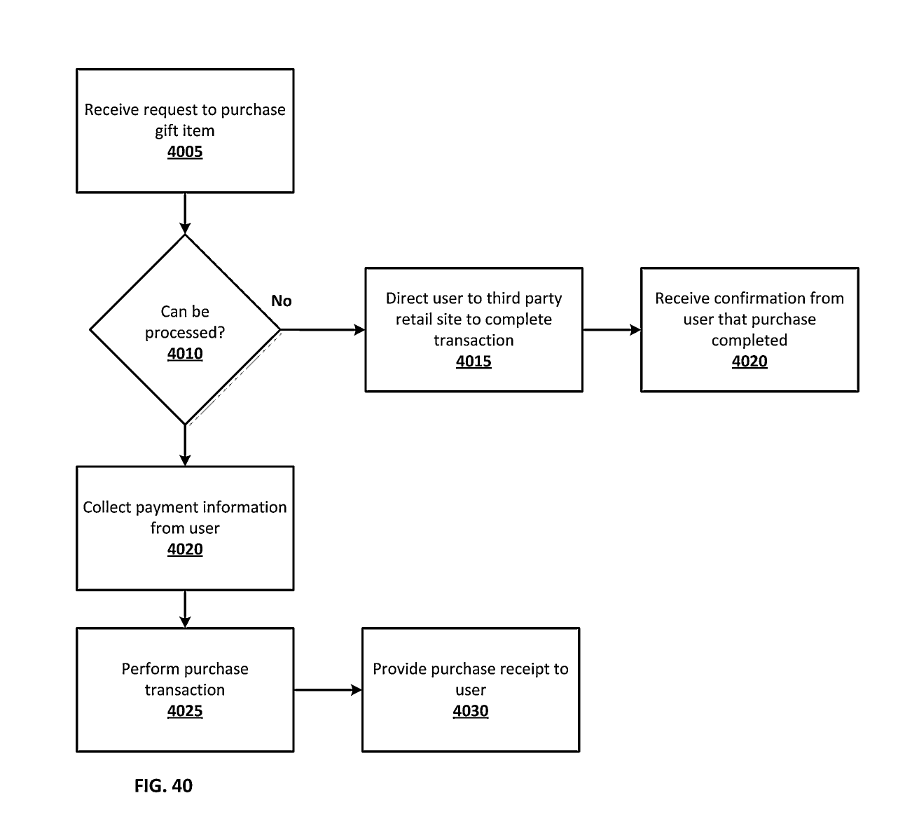

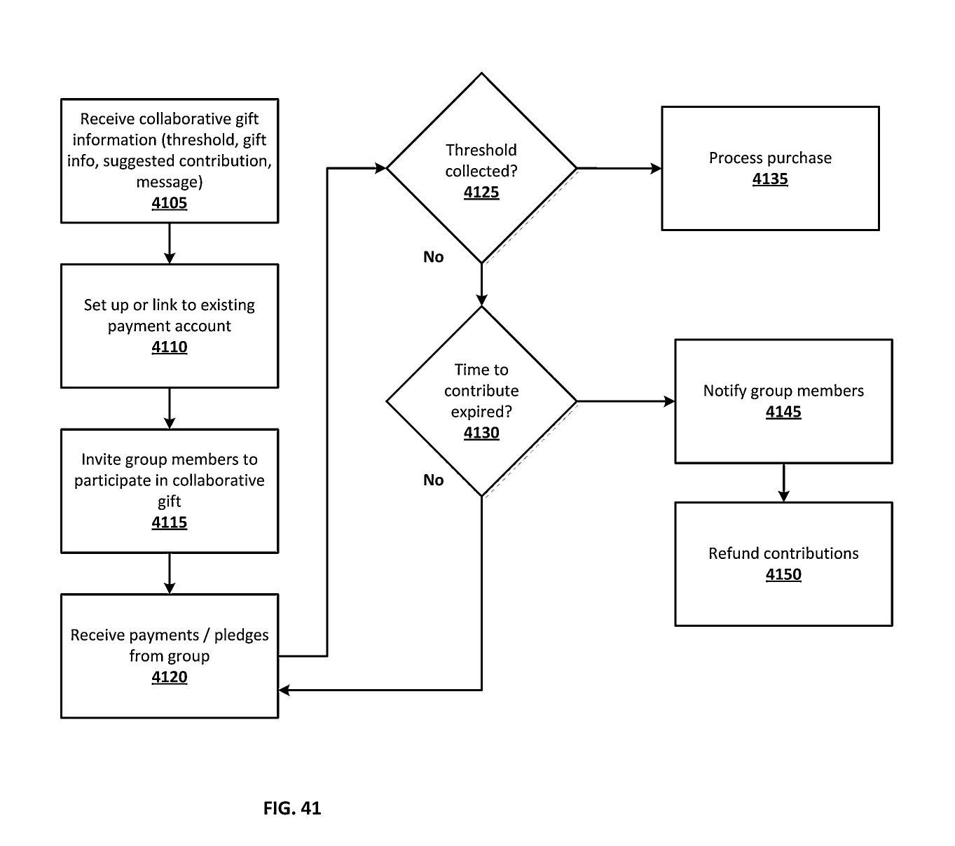

The gift collaboration system can then be configured to make a determination whether the user has requested a collaborative gift purchase (stage 3920). If the user claiming the gift has requested that the gift be a collaborative purchase, the gift collaboration system can be configured to perform a collaborative gift purchasing procedure (stage 3930). Collaborative purchasing involves contributions from multiple members of the group. A collaborative purchasing procedure is illustrated in FIG. 41. Otherwise, if the gift collaboration system determines that the purchase is not a collaborate purchase, the gift collaboration system can perform a non-collaborative purchasing procedure (stage 3925) where the user claiming the gift pays for the entire purchase of the gift and does not solicit or receive contributions from other members of the group. A non-collaborative purchasing procedure is illustrated in FIG. 40.

FIG. 40 is a flow diagram of a method for processing a request to purchase a gift in the gift collaboration system. The gift collaboration system can receive request to purchase gift item (stage 4005). For example, a user can click the claim gift button 925 on the gift idea interface 900. The gift idea interface 900 can be configured to prompt the user whether the user would like to purchase the claimed gift. If the user answers affirmatively, the gift collaboration system can be configured to determine whether purchase can be processed by gift collaboration system (stage 4015). The purchasing module 230 can be configured to determine whether a particular product can be purchased through the gift collaboration system from an online affiliate or whether the gift is only available from a non-affiliated retailer. The purchasing module 230 can be configured to process payments for affiliated online retailers. The purchasing module 230 can be configured to determine whether a particular gift item is available from an affiliated or non-affiliated retailer based on the gift idea information associated with the gift item. The gift idea information entered by the user can be examined to determine whether the item was selected from a particular retailer. The purchasing module 230 can also be integrated with the advertising module 236, and the purchasing module 230 can be configured to instruct the advertising module 236 to search for and display related items when a user claims and/or purchases an item for a receiver. The advertising module 236 can display one or more related items to the user and the user can be provided with the opportunity to purchase the related items for the receiver and/or to associate one or more of the related items with the group as a gift item. If one or more of the related items are associated with the group as a gift item, the members of the group can discuss these items with other members of the group and can also claim or purchase these items.

If the item to be purchased is available from an affiliated online retailer, the purchasing module 230 can be configured to collect payment information from user (stage 4020). For example, the purchasing module 230 may offer various payment methods, such as electronic funds transfer (EFT), credit card processing, or payments via a third party payment processor, such as PayPal, Amazon Payments, Google Checkout, or other payment processing service. The purchasing module 230 can then perform purchase transaction (stage 4025) using the payment method requested by the user. The purchasing module 230 can be configured to interface with affiliated retailers to complete the purchase of the gift item from the online retailer. The purchasing module can also be configured to provide purchase receipt to user (stage 4030) once the purchase has been completed. The receipt for the purchase can be sent to the user electronically via email or displayed to the user on a web page that the user can elect to print.

Alternatively, if the gift item that the user would like to purchase is not available from an affiliated online retailer, the gift collaboration system can be configured to direct user to third party retail site to complete transaction (stage 4015). For example, a user may have associated a gift item with a gift idea where the gift item is available from a retailer that is not affiliated with the gift collaboration system. The gift collaboration system can be configured to direct the user to a webpage for the retailer offering the product if available. The gift item information provided by the user who associated the gift item with a gift idea may include the URL of the webpage of the retailer offering the gift item for sale. If the URL is not available, the gift collaboration system can be configured to display a message to the user that the URL of the retailer is not available and the gift item information that is available can be presented to the user. The gift collaboration system can also be configured to receive confirmation from user that purchase completed (stage 4020). The user can confirm that the user has purchased the gift item that the user claimed and the gift collaboration system can optionally update the gift item as to a purchased state.

FIG. 41 is a flow diagram of a method for processing a request for collaborative purchasing of a gift in the gift collaboration system. The method illustrated in FIG. 41 can be used to implement stage 3930 in the method illustrated in FIG. 39.

The gift collaboration system can receive collaborative gift information from a user (stage 4105). The collaborative gift information can be collected by the gift idea interface 900 when the user identifies a claimed gift item as a collaborative purchase. The gift idea interface 900 can be configured to collect information about the collaborative purchase including: a threshold amount that needs to be collected to purchase the gift, gift information describing the gift and identifying an online retailer selling the gift (if available), a suggested contribution amount for contributions from the members of the group, and a collaborative purchase message to be displayed to members of the group viewing the gift item. The threshold can define a minimum amount of money to be collected from or pledged by members of the group in order for the collaborative purchase to be completed. The threshold amount can equal the price of the item to be purchased, but the user could configure the threshold such that if a particular dollar amount or percentage of the purchase price is contributed by members of the group, the user setting up the collaborative purchase will pay the remaining amount due for the gift item. The user can also specify whether the contributors will need to pay money upfront or can pledge money toward the collaborative gift. If pledges are allowed, no money would be collected from those pledging money toward the gift until the threshold amount of pledges are received.

The gift collaboration system can then receive account information for a payment account from the user to link to an existing user account or prompt the user to create a new payment account and link to newly created account (stage 4110). The payment account is an account where the contributions toward the gift account can be deposited. For example, the payment account could be a bank account, a credit card account, or an account with a payment service, such as PayPal or other payment service provider who provides similar types of payment services. The user can be prompted to set up a new account and link to that account or can provide information identifying an existing payment account. Some collaborative gifts can be set up such that the users make pledges toward a target amount, and the pledges are not collected from users until the pledges exceed a threshold amount. In the pledge situation, a payment account can still be set up to collect the money from the users once the pledges exceed the threshold amount set by the user who set up the collaborative payment.

The user can also provide a set of invitees who are invited to participate in the collaborative gift (stage 4115). Step 4115 is similar to that of steps illustrated in the method illustrated in FIG. 37. The user can select members of the group to participate in the collaborative payment. The user can select a subset of members of the group to participate or can elect to invite all members in the group to participate. The invitation processing module 224 of the gift collaboration system can then be configured to send invitations to the set of invitees identified by the user, and can collect responses from the invitees. Those invites that affirmatively respond to the invitation can be added to the members of the group that can participate in the collaborative payment.

Once members have been added to the collaborative payment group, the purchasing module 230 can receive payments toward the gift item and/or pledges toward the gift item from members of the collaborative payment group (stage 4120). Depending on how the collaborative payment group was setup, the members of the group may be able to make payments toward the collaborative gift and/or pledge an amount toward the collaborative gift. If a pledge is made, the member making the pledge is not charged for the pledge amount until the funding threshold for the collaborative gift is reached. The collaborative gift can also have been set up to limit the payments to pledges to fixed amounts or to a minimum or maximum amount per member of the collaborative payment group. For example, the pledge or payment amounts might be limited to be in $10 increments or may have a minimum payment constraint of $5 and a maximum payment constraint of $25 associated with them.

A determination can be made whether the threshold amount for the collaborative gift has been reached (stage 4125). As described above, the threshold amount can equal the price of the item to be purchased, but the user could configure the threshold such that if a particular dollar amount or percentage of the purchase price is contributed by members of the group, the user setting up the collaborative purchase will pay the remaining amount due for the gift item. The purchasing module 230 can compare the total amount of payments and or pledges made toward the collaborative gift to the threshold amount.

If threshold amount has been collected, the gift item associated with the collaborative gift can be purchased (stage 4135). If the threshold amount has been met, the purchasing module 230 can be configured to apply the collected funds toward the purchase of the gift item. If pledges were collected instead of monetary contributions, the purchasing module 230 can be configured to debit the accounts of each of the users who pledged money and apply the collected money toward the purchase of the gift item. The purchasing process can operate similarly to the non-collaborative purchase method illustrated in FIG. 40 once the funds have been collected for the collaborative gift.

If the threshold amount has not yet been collected, a determination can be made whether the deadline to contribute toward the collaborative gift has expired (stage 4130). The user creating the collaborative payment toward the gift can specify a date and/or time deadline by which the threshold amount for the collaborative gift must be received. The purchasing module 230 can compare this deadline to the current date and/or time if the threshold amount has not yet been met. The purchasing module 230 can be configured to send out a reminder to members of the group that the target amount has not yet been collected for the gift and a reminder of the deadline to participate in the collaborative purchase of the gift item.

If the deadline to contribute to toward the collaborative purchase has expired, the purchasing module 230 can be configured to notify group members that the collaborative payment deadline has expired and the target threshold amount for the purchase was not received (stage 4145). The purchasing module 230 can be configured to send a text message, an email message, a social networking message, or other types of message to the members of the group to indicate that the collaborative purchase did not meet its goal and has expired. The purchasing module 230 can also be configured to refund any payments that were made toward the collaborative purchase to the user who made those payments (stage 4150). The purchasing module 230 can also be configured to cancel any pledges that were made toward the collaborative purchase. In some implementations, the purchasing module 230 can be configured to send a message to the user who created the collaborative purchase to see if the user would like to extend the deadline for meeting the goals for the collaborative purchase prior to the refunding the payments, canceling pledges, and canceling the collaborative purchase.

If the deadline to contribute to toward the collaborative purchase has not yet expired, the method returns with stage 4120 to wait to receive payments/pledges from members of the collaborative payment group (stage 4125).

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

While the foregoing disclosure shows illustrative aspects and/or embodiments, it should be noted that various changes and modifications could be made herein without departing from the scope of the described aspects and/or embodiments as defined by the appended claims. For example, for enhanced security, it should be noted that data stored on wireless device and/or data stored on remote server may be stored in an encrypted format. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for facilitating collaboration on gift ideas for a receiver, the method comprising:
creating a group for discussing gift ideas for the receiver in response to a request from a user;
receiving a gift idea from a member of the group;
providing a group collaboration interface in which members of the group can post messages discussing the gift idea.

2. The method of claim 1, further comprising:
receiving a gift item idea associated with the gift idea from a member of the group; and
associating the gift item idea received from the member of the group with the gift idea.

3. The method of claim 2, further comprising:
displaying the gift item idea received from the member of the group in the group collaboration interface.

4. The method of claim 1, further comprising:
receiving information about the receiver from one or more members of the group; and
associating the information about the receiver with the receiver.

5. The method of claim 1, further comprising:
receiving information identifying a person mentioned in message discussing the gift idea, the person not being a member of the group; and
inviting the person to join the group in response to receiving the message identifying the person.

6. The method of claim 1, further comprising:
associating the receiver with a known receiver based on one or more attributes of the known receiver and information associated with the user, the known receiver being associated with one or more other groups for discussing gift ideas for the known receiver.

7. The method of claim 6 wherein associating the receiver with a known receiver further comprises:
selecting a known receiver from a plurality of known receivers based on contact list information associated with the user, social network connection information associated with the user, or both.

8. The method of claim 6, further comprising:
suggesting gift items for the receiver based on the contents of the messages discussing the gift ideas, information associated with the known receiver, or both.

9. The method of claim 8 wherein suggesting gift items for the receiver further comprises:
displaying advertisements for gift items from affiliated retailers to members of the group;
receiving a request from a member of the group to associate a gift item included in an advertisement with the group; and
associating the gift item with the receiver.

10. The method of claim 1, further comprising:
inviting at least one invitee to become a member the group.

11. The method of claim 10 wherein inviting at least one invitee to become a member the group includes selecting invitees from social network contacts associated with the receiver, the user, or both.

12. The method of claim 10 wherein inviting at least one invitee to become a member the group includes selecting members from other groups associated with the receiver, the user, or both.

13. The method of claim 1, further comprising:
receiving an indication from a member of the group that the member of the group would like to claim the gift, wherein claiming the gift indicates that the member of the group would like to purchase the gift for the receiver.

14. The method of claim 13, further comprising:
marking the gift as claimed in the group collaboration interface responsive to the gift being claimed; and
preventing other members of the group from claiming the gift responsive to the gift being claimed by the user.

15. The method of claim 13, further comprising:
receiving an indication from the member of the group that the member of the group would like to purchase the gift for the receiver; and
providing an interface for purchasing the gift from an online retailer offering the gift for sale.

16. The method of claim 15 wherein providing the interface for purchasing the gift from an online retailer includes providing an interface that allows the member of the group to designate the gift as a collaborative gift.

17. The method of claim 16, further comprising:
collecting contributions toward a cost of the gift from members of the group; and
purchasing the gift from the online retailer responsive to the contributions toward the gift meeting or exceeding a threshold amount of contributions.

18. The method of claim 17, further comprising:
determining whether the threshold amount of contributions toward the cost of the gift has been received from members of the group;
determining whether a deadline for reaching the threshold amount of contributions has expired; and
refunding the contributions toward the gift responsive to the deadline for reaching the threshold amount of contributions having expired and the threshold amount of contributions toward the cost of the gift having not been received.

19. A system for facilitating collaboration on gift ideas for a receiver, the system comprising:
means for creating a group for discussing gift ideas for the receiver in response to a request from a user;
means for receiving a gift idea from a member of the group;
means for providing a group collaboration interface in which members of the group can post messages discussing the gift idea.

20. The system of claim 19, further comprising:
means for receiving a gift item idea associated with the gift idea from a member of the group; and
means for associating the gift item idea received from the member of the group with the gift idea.

21. The system of claim 20, further comprising:
means for displaying the gift item idea received from the member of the group in the group collaboration interface.

22. The system of claim 19, further comprising:
means for receiving information about the receiver from one or more members of the group; and
means for associating the information about the receiver with the receiver.

23. The system of claim 19, further comprising:
means for receiving information identifying a person mentioned in message discussing the gift idea, the person not being a member of the group; and
means for inviting the person to join the group in response to receiving the message identifying the person.

24. The system of claim 19, further comprising:
means for associating the receiver with a known receiver based on one or more attributes of the known receiver and information associated with the user, the known receiver being associated with one or more other groups for discussing gift ideas for the known receiver.

25. The system of claim 24 wherein the means for associating the receiver with a known receiver further comprises:
means for selecting a known receiver from a plurality of known receivers based on contact list information associated with the user, social network connection information associated with the user, or both.

26. The system of claim 25, further comprising:
means for suggesting gift items for the receiver based on the contents of the messages discussing the gift ideas, information associated with the known receiver, or both.

27. The system of claim 26 wherein the means for suggesting gift items for the receiver further comprises:
means for displaying advertisements for gift items from affiliated retailers to members of the group;
means for receiving a request from a member of the group to associate a gift item included in an advertisement with the group; and
means for associating the gift item with the receiver.

28. The system of claim 19, further comprising:
means for inviting at least one invitee to become a member the group.

29. The system of claim 28 wherein the means for inviting at least one invitee to become a member the group includes means for selecting invitees from social network contacts associated with the receiver, the user, or both.

30. The system of claim 28 wherein the means for inviting at least one invitee to become a member the group includes means for selecting members from other groups associated with the receiver, the user, or both.

31. The system of claim 19, further comprising:
means for receiving an indication from a member of the group that the member of the group would like to claim the gift, wherein claiming the gift indicates that the member of the group would like to purchase the gift for the receiver.

32. The system of claim 31, further comprising:
means for marking the gift as claimed in the group collaboration interface responsive to the gift being claimed; and
means for preventing other members of the group from claiming the gift responsive to the gift being claimed by the user.

33. The system of claim 31, further comprising:
means for receiving an indication from the member of the group that the member of the group would like to purchase the gift for the receiver; and
means for providing an interface for purchasing the gift from an online retailer offering the gift for sale.

34. The system of claim 33 wherein the means for providing the interface for purchasing the gift from an online retailer includes means for providing an interface that allows the member of the group to designate the gift as a collaborative gift.

35. The system of claim 34, further comprising:
means for collecting contributions toward a cost of the gift from members of the group; and
means for purchasing the gift from the online retailer responsive to the contributions toward the gift meeting or exceeding a threshold amount of contributions.

36. The system of claim 35, further comprising:
means for determining whether the threshold amount of contributions toward the cost of the gift has been received from members of the group;
means for determining whether a deadline for reaching the threshold amount of contributions has expired; and
means for refunding the contributions toward the gift responsive to the deadline for reaching the threshold amount of contributions having expired and the threshold amount of contributions toward the cost of the gift having not been received.

37. A computer-readable storage medium, having stored thereon computer-readable instructions for facilitating collaboration on gift ideas for a receiver, comprising instructions configured to cause at least one processor to:
create a group for discussing gift ideas for the receiver in response to a request from a user;
receive a gift idea from a member of the group;
provide a group collaboration interface in which members of the group can post messages discussing the gift idea.

38. A system for facilitating collaboration on gift ideas for a receiver, the method comprising:
a non-transitory computer-readable memory;
a plurality of modules comprising processor executable code stored in the non-transitory computer-readable memory;
a processor connected to the non-transitory computer-readable memory and configured to access the plurality of modules stored in the non-transitory computer-readable memory; and
a group module configured to create a group for discussing gift ideas for the receiver in response to a request from a user;
a user interface module configured to receive a gift idea from a member of the group and to provide a group collaboration interface in which members of the group can post messages discussing the gift idea.

39. A method for tagging people in a social networking service, the method comprising:
receiving information identifying a person mentioned in message posted to the social networking service;
determining whether the person is a member of the social networking service; and
inviting the person to join the social networking service responsive to the person not being a member of the social networking service.

40. The method of claim 39, further comprising:
associating the information identifying the person with the member of the social networking service.
